(19) United States
(12) Patent Application Publication
(10) Pub. No.: US 2026/0202193 A1
(43) Pub. Date: Jul. 16, 2026

(54) IMAGE ACQUIRING DEVICE AND IMAGE ACQUIRING METHOD

(71) Applicant: Mitsubishi Electric Corporation, Tokyo (JP)

(72) Inventors: Wataru YOSHIKI, Tokyo (JP); Masaharu IMAKI, Tokyo (JP)

(73) Assignee: Mitsubishi Electric Corporation, Tokyo (JP)

(21) Appl. No.: 19/557,984

(22) Filed: Mar. 5, 2026

Related U.S. Application Data
(63) Continuation of application No. PCT/JP2023/040319, filed on Nov. 9, 2023.

(51) Int. Cl. G01B 11/25; G06T 7/246; G06T 7/60

(52) U.S. Cl. CPC G01B 11/254; G06T 7/246; G06T 7/60

(57) ABSTRACT

An image acquiring device includes: an illumination system unit to irradiate a measurement target with an illumination pattern applied with a two-dimensional pattern formed using a plurality of sections and a shift illumination pattern obtained by shifting the illumination pattern along an irradiation surface; a reception unit to receive, via a single pixel photodetector, light from the measurement target when the illumination pattern and the shift illumination pattern are irradiated onto the measurement target by the illumination system unit; and a signal processing unit to acquire a reception signal based on the light received by the reception unit and generate a two-dimensional image of the measurement target on the basis of a change in the reception signal when the measurement target passes on the illumination pattern and a change in the reception signal when the measurement target passes on the shift illumination pattern.

### CROSS REFERENCE TO RELATED APPLICATIONS

This application is a Continuation of: PCT International Application No. PCT/JP2023/040319 filed on Nov. 9, 2023, all of which is hereby expressly incorporated by reference into the present application.

### TECHNICAL FIELD

The technology of the present disclosure relates to an image acquiring technique for acquiring an image of a measurement target by irradiating an illumination pattern formed using a two-dimensional pattern.

### BACKGROUND ART

Among image acquiring techniques, there is a technology called single pixel imaging (SPI). In SPI, a measurement target is irradiated with a large number of two-dimensional illumination patterns, and reflected light and scattered light from the measurement target are recorded by a single pixel detector. By associating the illuminated two-dimensional pattern with reception signal intensity and applying signal processing to the information, a two-dimensional image of the measurement target can be acquired even though only a single pixel detector is used. SPI is a technique particularly useful in a wavelength band in which a two-dimensional array detector is expensive or difficult to implement, but, on the other hand, requires a spatial light modulator capable of dynamically controlling a display pattern such as a digital micromirror device (DMD) in order to generate a large number of two-dimensional patterns.

On the other hand, Non Patent Literature 1 describes a technique of acquiring a two-dimensional image of a measurement target moving at a constant speed by simply irradiating the measurement target with a single illumination pattern. The positional relationship between the measurement target and the illumination pattern changes as the measurement target moves at a constant speed. Thus, since an apparent illumination pattern (hereinafter, also referred to as an illumination frame) with which the measurement target is irradiated changes, a two-dimensional image can be acquired on the same principle as that of general SPI. In this configuration, since a single illumination pattern is sufficient, it is not necessary to dynamically change the illumination pattern, and a spatial light modulator such as a DMD is not necessary.

### CITATION LIST

### Non Patent Literatures

Non Patent Literature 1: Ota et al., Science 360, 1246-1251 (2018)
Non Patent Literature 2: Edgar et al., Nat. Photonics 13, 13-20 (2019)

### SUMMARY OF INVENTION

### Technical Problem

However, when SPI is performed with the configuration as illustrated in Non Patent Literature 1, the number of virtual illumination patterns (illumination frames) is proportional to the length of the illumination pattern in a measurement target moving direction, and thus there is a problem that the size of the illumination pattern increases as the number of illumination frames is increased in order to ensure image acquisition accuracy.

The present disclosure has been made to solve the above problems, and an object thereof is to provide a technique for increasing the number of virtual illumination patterns (illumination frames) while suppressing an increase in the size of an illumination pattern in a case where a two-dimensional image of a measurement target is acquired using a single illumination pattern.

### Solution to Problem

An image acquiring device according to the present disclosure includes:
an illumination system to irradiate a measurement target with an illumination pattern applied with a two-dimensional pattern formed using a plurality of sections and a shift illumination pattern obtained by shifting the illumination pattern along an irradiation surface;
a receptor to receive, via a single pixel photodetector, light from the measurement target when the illumination pattern and the shift illumination pattern are irradiated onto the measurement target by the illumination system; and
a signal processor to acquire a reception signal based on the light received by the receptor and generate a two-dimensional image of the measurement target on the basis of a change in the reception signal when the measurement target passes on the illumination pattern and a change in the reception signal when the measurement target passes on the shift illumination pattern.

### Advantageous Effects of Invention

According to the present disclosure, there is an effect that it is possible to increase the number of virtual illumination patterns (illumination frames) while suppressing an increase in the size of an illumination pattern in a case where a two-dimensional image of a measurement target is acquired using a single illumination pattern.

### BRIEF DESCRIPTION OF DRAWINGS

FIG. 1 is a diagram illustrating a basic configuration example of an image acquiring device 100 according to a first embodiment of the present disclosure.

FIG. 2 is a diagram illustrating an example of basic operation of the image acquiring device 100 according to the first embodiment of the present disclosure.

FIG. 3 is a diagram illustrating a configuration example of an image acquiring device 100A according to a second embodiment of the present disclosure and a configuration example in a case where the image acquiring device 100A is applied to a measurement system.

FIG. 4 is a diagram illustrating a configuration example of an illumination system unit 110A in the image acquiring device 100A according to the second embodiment of the present disclosure.

FIG. 5 is a diagram illustrating a configuration example of a signal processing unit 150A in the image acquiring device 100A according to the second embodiment of the present disclosure.

FIG. 6 is a flowchart illustrating a processing example of the signal processing unit 150A in the image acquiring device 100A according to the second embodiment of the present disclosure.

FIG. 7 is a diagram for describing an operation related to acquisition of a reception signal in the image acquiring device 100A according to the second embodiment of the present disclosure.

FIG. 8 is a diagram for describing processing related to the signal processing unit 150A in the image acquiring device 100A according to the second embodiment of the present disclosure.

FIG. 9 is a diagram illustrating a configuration example of an image acquiring device 100B according to a third embodiment of the present disclosure and a configuration example in a case where the image acquiring device 100B is applied to a measurement system.

FIG. 10 is a diagram illustrating a configuration example of an illumination system unit 110B in the image acquiring device 100B according to the third embodiment of the present disclosure.

FIG. 11 is a diagram illustrating a configuration example of a signal processing unit 150B in the image acquiring device 100B according to the third embodiment of the present disclosure.

FIG. 12 is a diagram for describing an operation related to acquisition of a reception signal in the image acquiring device 100B according to the third embodiment of the present disclosure.

FIG. 13 is a diagram for describing processing related to the signal processing unit 150B in the image acquiring device 100B according to the third embodiment of the present disclosure.

FIG. 14 is a diagram illustrating a configuration example of an image acquiring device 100C according to a fourth embodiment of the present disclosure and a configuration example in a case where the image acquiring device 100C is applied to a measurement system.

FIG. 15 is a diagram illustrating a first configuration example of an illumination system unit 110C in the image acquiring device 100C according to the fourth embodiment of the present disclosure.

FIG. 16 is a diagram illustrating a second configuration example of the illumination system unit 110C in the image acquiring device 100C according to the fourth embodiment of the present disclosure.

FIG. 17 is a diagram illustrating a configuration example of a signal processing unit 150C in the image acquiring device 100C according to the fourth embodiment of the present disclosure.

FIG. 18 is a diagram for describing an operation related to acquisition of a reception signal in the image acquiring device 100C according to the fourth embodiment of the present disclosure.

FIG. 19 is a diagram illustrating a configuration example of an image acquiring device 100D according to a fifth embodiment of the present disclosure and a configuration example in a case where the image acquiring device 100D is applied to a measurement system.

FIG. 20 is a diagram illustrating a configuration example of a signal processing unit 150D in the image acquiring device 100D according to the fifth embodiment of the present disclosure.

FIG. 21 is a diagram for describing an operation related to acquisition of a reception signal in the image acquiring device 100D according to the fifth embodiment of the present disclosure.

FIG. 22 is a diagram for describing processing related to the signal processing unit 150D in the image acquiring device 100D according to the fifth embodiment of the present disclosure.

FIG. 23 is a diagram illustrating a first example of a hardware configuration for implementing the function according to the present disclosure.

FIG. 24 is a diagram illustrating a second example of a hardware configuration for implementing the function according to the present disclosure.

### DESCRIPTION OF EMBODIMENTS

An image acquiring device of the present disclosure utilizes SPI technique that illuminates a measurement target in a two-dimensional pattern and captures reflection and scattering of illumination light from the measurement target with a single pixel detector to obtain a two-dimensional image of the measurement target.

In general SPI, a measurement target is irradiated with a large number of illumination patterns, and a reception signal intensity corresponding thereto is recorded. Classically, in order to completely acquire an image as a measurement target, the number of illumination patterns needs to be larger than the total number of pixels of an acquired image (if the resolution is 640×480, the total number of pixels is 640×480). Although it is possible to reduce the number of necessary illumination patterns by applying a signal processing method using a principle of compression sensing, a certain number or more of illumination patterns are still required in order to improve image acquisition accuracy.

In addition, as described above, when SPI is performed with a configuration as illustrated in Non Patent Literature 1, the number of virtual illumination patterns (illumination frames) is proportional to lengths of the illumination patterns in a movement direction of the measurement target, and thus, as the number of illumination frames is increased to ensure image acquisition accuracy, the size of the illumination patterns increases.

The image acquiring device of the present disclosure makes it possible to increase the number of virtual illumination patterns (illumination frames) while suppressing an increase in the size of an illumination pattern in a case where a two-dimensional image of a measurement target is acquired using a single illumination pattern.

Hereinafter, in order to describe the present disclosure in more detail, embodiments of the present disclosure will be described with reference to the accompanying drawings.

### First Embodiment

In a first embodiment, a basic form of the present disclosure will be described.

### [Configuration]

A configuration example of an image acquiring device according to the first embodiment of the present disclosure will be described.

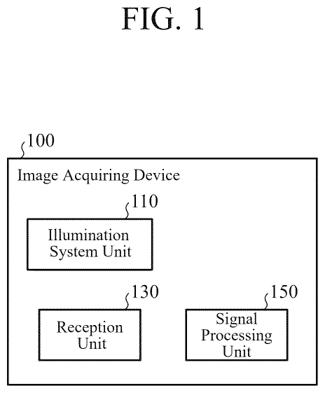

FIG. 1 is a diagram illustrating a basic configuration example of the image acquiring device according to the first embodiment of the present disclosure.

An image acquiring device 100 irradiates a measurement target with an illumination pattern applied with a two-dimensional pattern formed using a plurality of sections and a shift illumination pattern obtained by shifting the illumination pattern along an irradiation surface, receives light from the measurement target when the measurement target is irradiated with the illumination pattern and the shift illumination pattern via a single pixel photodetector, acquires a reception signal based on the received light, and generates a two-dimensional image of the measurement target on the basis of a change in the reception signal when the measurement target passes on the illumination pattern and a change in the reception signal when the measurement target passes on the shift illumination pattern.

The image acquiring device 100 illustrated in FIG. 1 includes an illumination system unit 110, a reception unit 130, and a signal processing unit 150.

The illumination system unit 110 irradiates the measurement target with an illumination pattern applied with a two-dimensional pattern formed using a plurality of sections and a shift illumination pattern obtained by shifting the illumination pattern along an irradiation surface.

The irradiation surface is, for example, the same or substantially the same as a surface on which a measurement target that is a target from which an image is to be acquired by the image acquiring device 100 is located or a surface on which the measurement target passes. Further, for example, it is the same or substantially the same surface as a movement surface for moving the measurement target.

The irradiation surface only needs to be set in such a manner that the illumination pattern and the shift illumination pattern can be irradiated onto a region where an image of a measurement target from which an image is to be acquired by the image acquiring device 100 can be acquired.

The illumination pattern has, for example, a two-dimensional pattern structure provided using a plurality of sections obtained by periodically dividing a rectangular irradiation region. The illumination pattern is formed in such a manner that light is allowed to pass through or is not allowed to pass through each of the plurality of sections.

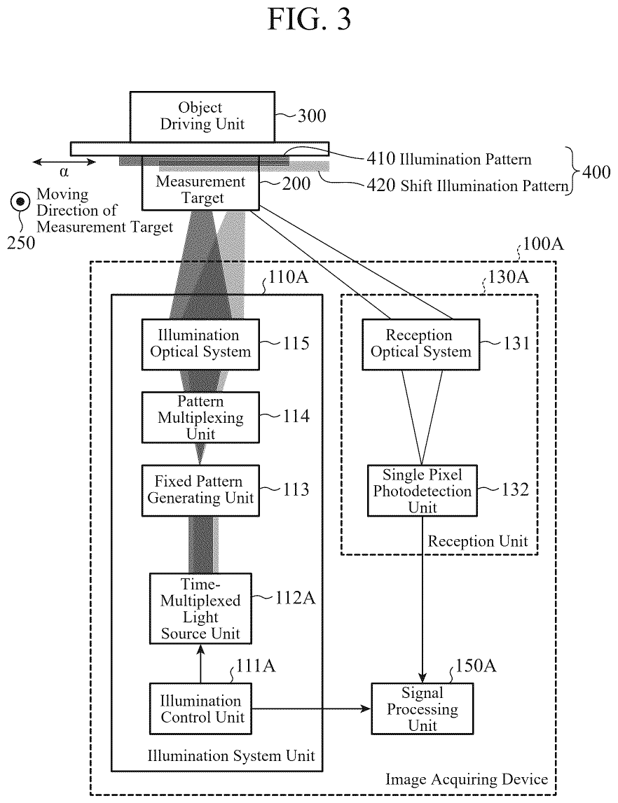

The shift illumination pattern is one that is irradiated by shifting the illumination pattern along the irradiation surface. For example, in a case where a measurement target that is a target from which an image is to be acquired by the image acquiring device 100 is moving, the shift illumination pattern is a pattern that is shifted in a direction (a direction α illustrated in FIG. 3 and the like to be described later) vertical to a moving direction (a moving direction 250 illustrated in FIG. 3 and the like to be described later) of a movement surface of the measurement target and is irradiated.

That is, a relative position in a horizontal direction between the measurement target and the illumination pattern and a relative position in a horizontal direction between the measurement target and the shift illumination pattern do not change.

The illumination pattern and the shift illumination pattern are formed by applying a single two-dimensional pattern to light.

The illumination system unit 110 includes, for example, a light source, a configuration for applying a pattern to light, and an illumination optical system.

The reception unit 130 receives light from the measurement target through the single pixel photodetector when the illumination pattern and the shift illumination pattern are irradiated onto the measurement target by the illumination system unit.

The reception unit 130 includes, for example, a single pixel photodetector.

The signal processing unit 150 acquires a reception signal based on the light received by the reception unit, and generates a two-dimensional image of the measurement target on the basis of a change in the reception signal when the measurement target passes on the illumination pattern and a change in the reception signal when the measurement target passes on the shift illumination pattern.

In addition to the above configuration, the image acquiring device 100 includes a control unit which is not illustrated, a storage unit which is not illustrated, and a communication unit which is not illustrated.

The control unit not illustrated controls the entire image acquiring device 100 and each component. The control unit not illustrated activates the image acquiring device 100 in accordance with a command from the outside of the device, for example. Further, the control unit not illustrated controls the state (operating state=a state such as activation, shutdown, or sleep) of the image acquiring device 100.

The storage unit not illustrated stores each piece of data used for the image acquiring device 100. The storage unit not illustrated stores, for example, an output (output data) from each component in the image acquiring device 100, and outputs data requested for each component to the component of the request source.

The communication unit not illustrated communicates with an external device. For example, communication is performed between the image acquiring device 100 (100A) and a peripheral device (for example, a display device). For example, in a case where the image acquiring device 100 and the display device are not connected by wire, the communication unit not illustrated has a function of performing communication between the image acquiring device 100 and the display device. In addition, the communication unit not illustrated has a function of performing communication with a server device which is an external device.

The control unit not illustrated, a storage unit not illustrated, and a communication unit not illustrated are similar in the embodiments described later.

### [Operation]

A processing example of the image acquiring device will be described.

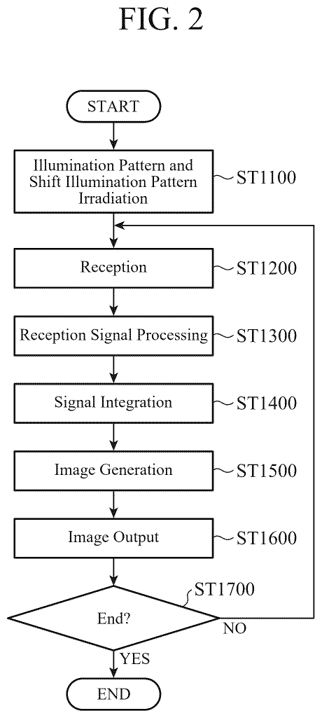

FIG. 2 is a diagram illustrating an example of basic operation of the image acquiring device 100 according to the first embodiment of the present disclosure.

Processing illustrated in FIG. 2 is an image acquiring method by the image acquiring device 100.

For example, the image acquiring device illustrated in FIG. 1 starts the processing illustrated in FIG. 2 by being instructed to start the operation from the outside of the device. Alternatively, in a case where the presence of a measurement target is detected, the processing illustrated in FIG. 2 is started.

First, the image acquiring device 100 emits light applied with a two-dimensional pattern.

In irradiation processing, the illumination system unit 110 of the image acquiring device 100 irradiates an illumination pattern and a shift illumination pattern (step ST1100).

Specifically, the illumination system unit 110 irradiates the measurement target with an illumination pattern applied with a two-dimensional pattern formed using a plurality of sections and a shift illumination pattern obtained by shifting the illumination pattern along an irradiation surface.

Next, the image acquiring device 100 receives light (step ST1200).

In step ST1200, the reception unit 130 of the image acquiring device 100 receives light from the measurement target when the illumination pattern and the shift illumination pattern are irradiated onto the measurement target by the illumination system unit 110 via a single pixel photodetector.

The reception unit 130 outputs the received light to the signal processing unit 150 as a reception signal.

Next, the image acquiring device 100 executes reception signal processing (step ST1300).

In the reception signal processing, the signal processing unit 150 of the image acquiring device 100 acquires a reception signal based on the light received by the reception unit 130, performs signal processing with respect to a reception signal related to the illumination pattern, and performs signal processing with respect to a reception signal related to the shift illumination pattern.

The signal processing unit 150 associates a virtual illumination pattern (illumination frame) in which the imaging target is likely to be located in the entire illumination pattern with pixels indicated in the illumination pattern reception signal.

In addition, the signal processing unit 150 associates a virtual illumination pattern (illumination frame) in which the imaging target is likely to be located in the entire shift illumination pattern with pixels indicated in the reception signal related to the shift illumination pattern.

Next, the image acquiring device 100 executes signal integration processing (step ST1400).

In the signal integration processing, the signal processing unit 150 of the image acquiring device 100 integrates the reception signal related to the illumination pattern after the reception signal processing and the reception signal related to the shift illumination pattern after the reception signal processing. For example, the signal processing unit 150 integrates the reception signal related to the illumination pattern after the reception signal processing and the reception signal related to the shift illumination pattern after the reception signal processing by simply connecting the reception signal and the reception signal in sequence.

Next, the image acquiring device 100 executes image generation processing (step ST1500).

In the image generation processing, the signal processing unit 150 of the image acquiring device 100 generates an image by using the reception signal after the signal integration processing.

Next, the image acquiring device 100 executes image output processing (step ST1600).

In the image output processing, the signal processing unit 150 of the image acquiring device 100 outputs the generated image. The image acquiring device 100 outputs the image to the outside of the device, for example. Alternatively, the image is output to a display device, which is not illustrated.

Next, the image acquiring device proceeds to end determination processing (step ST1700).

In the end determination processing, the control unit not illustrated of the image acquiring device determines whether to end the processing of the image acquiring device. The control unit not illustrated determines whether to end the processing of the image acquiring device in accordance with, for example, an external end command or an execution program.

In a case where the control unit not illustrated determines not to end the processing of the image acquiring device (step ST1700 “NO”), the process proceeds to the processing of step ST1200, and the repetitive processing is performed from the processing of step ST1200.

When the control unit not illustrated determines to end the processing of the image acquiring device (step ST1700 “YES”), the image acquiring device ends the processing.

The image acquiring device of the present disclosure according to the present embodiment is configured as follows, for example.

An image acquiring device including:
an illumination system unit to irradiate a measurement target with an illumination pattern applied with a two-dimensional pattern formed using a plurality of sections and a shift illumination pattern obtained by shifting the illumination pattern along an irradiation surface;
a reception unit to receive, via a single pixel photodetector, light from the measurement target when the illumination pattern and the shift illumination pattern are irradiated onto the measurement target by the illumination system unit; and
a signal processing unit to acquire a reception signal based on the light received by the reception unit and generate a two-dimensional image of the measurement target on the basis of a change in the reception signal when the measurement target passes on the illumination pattern and a change in the reception signal when the measurement target passes on the shift illumination pattern.

Thus, the present disclosure has an effect of providing an image acquiring device capable of increasing the number of virtual illumination patterns (illumination frames) while suppressing an increase in the size of an illumination pattern in a case where a two-dimensional image of a measurement target is acquired using a single illumination pattern.

The image acquiring method of the present disclosure according to the present embodiment is configured as follows, for example.

An image acquiring method by an image acquiring device, the image acquiring method including:
by the image acquiring device, irradiating a measurement target with an illumination pattern applied with a two-dimensional pattern formed using a plurality of sections and a shift illumination pattern obtained by shifting the illumination pattern along a pattern surface;
by the image acquiring device, receiving light from the measurement target irradiated with the illumination pattern and the shift illumination pattern via a single pixel photodetector; and
by the image acquiring device, acquiring a reception signal based on the light received via the single pixel photodetector, and generating a two-dimensional image of the measurement target on the basis of a change in the reception signal when the measurement target passes on the illumination pattern and a change in the reception signal when the measurement target passes on the shift illumination pattern.

Thus, the present disclosure has an effect of providing an image acquiring method capable of increasing the number of virtual illumination patterns (illumination frames) while suppressing an increase in the size of an illumination pattern in a case where a two-dimensional image of a measurement target is acquired using a single illumination pattern.

### Second Embodiment

A second embodiment describes a more detailed mode example of the first embodiment.

In the second embodiment, among the components according to the second embodiment, components that are the same as or similar to the components according to the first embodiment already described are denoted by the same names and the same or similar reference numerals, and redundant description is appropriately omitted.

### [Configuration]

FIG. 3 is a diagram illustrating a configuration example of an image acquiring device 100A according to the second embodiment of the present disclosure and a configuration example in a case where the image acquiring device 100A is applied to a measurement system.

The measurement system is configured to move a measurement target, acquires an image of the measurement target using an image acquiring device, measures the measurement target using the acquired image, performs inspection, and outputs an inspection result.

The image acquiring device 100A illustrated in FIG. 3 includes an illumination system unit 110A, a reception unit 130A, and a signal processing unit 150A.

The illumination system unit 110A emits the illumination pattern and one or more shift illumination patterns obtained by shifting the illumination pattern by an illumination pattern shift unit while switching between them depending on the lapse of time.

A relative position between the measurement target and the illumination pattern in the horizontal direction and a relative position between the measurement target and the shift illumination pattern in the horizontal direction do not change upon switching between the illumination pattern and the shift illumination pattern.

The horizontal direction is the same direction as the moving direction 250 of the movement surface on which the measurement target is moved in a state where the image acquiring device 100A is disposed in such a manner as to acquire an image of the measurement target to be moved.

The illumination system unit 110A illustrated in FIG. 3 includes an illumination control unit 111A, a time-multiplexed light source unit 112A, a fixed pattern generating unit 113, a pattern multiplexing unit 114, and an illumination optical system 115.

The illumination control unit 111A has a function of controlling switching of a wavelength of output light from the time-multiplexed light source unit 112 and a function of transmitting a timing of switching of the wavelength to the signal processing unit 150A.

The time-multiplexed light source unit 112A has a function of irradiating the fixed pattern generating unit 113 with two light beams having different wavelengths while switching between them on the basis of control from the illumination control unit 111A.

The time-multiplexed light source unit 112A constitutes a light source unit in the present disclosure.

The fixed pattern generating unit 113 has a function of applying a spatial modulation pattern to the light irradiated from the time-multiplexed light source unit 112.

The spatial pattern generated by the fixed pattern generating unit 113 is always the same, and does not have a function of dynamically changing the pattern unlike a spatial light modulator represented by a DMD. That is, the fixed pattern generating unit 113 has a static structure.

Thus, the fixed pattern generating unit 113 and the optical system and the control system around the fixed pattern generating unit are reduced in size and cost, and enhanced in reliability.

The fixed pattern generating unit 113 constitutes a pattern generating unit of the present disclosure.

The pattern generating unit (fixed pattern generating unit 113) applies a two-dimensional pattern to the light emitted from the light source unit (time-multiplexed light source unit 112A).

The pattern generating unit (fixed pattern generating unit 113) has a static structure that gives the single two-dimensional pattern to the light emitted from the light source unit (time-multiplexed light source unit 112A).

The illumination optical system 115 has a function of transferring the spatial modulation pattern applied to the light passing through the fixed pattern generating unit 113 to a measurement target 200.

The transferred modulation pattern is an illumination pattern 410 or a shift illumination pattern 420. The illumination optical system 115 is an imaging optical system including a lens and a mirror, and the shape and the number of lenses and mirrors are not limited.

The illumination optical system 115 of the present disclosure projects light to which a two-dimensional pattern is applied by the pattern generating unit (fixed pattern generating unit 113) onto the measurement target.

The pattern multiplexing unit 114 has a function of switching the modulation pattern transferred to the measurement target 200 to either the illumination pattern 410 or the shift illumination pattern 420 in accordance with the wavelength of the light by imparting refraction depending on the wavelength to the light passing through the fixed pattern generating unit 113. The pattern multiplexing unit 114 is a wavelength dispersion element including a prism and a diffraction grating.

The pattern multiplexing unit 114 constitutes an illumination pattern shift unit of the present disclosure.

The illumination pattern shift unit (pattern multiplexing unit 114) shifts the illumination pattern generated by the illumination optical system 115.

The illumination pattern 410 illustrated in FIG. 3 is a two-dimensional spatial modulation pattern transferred onto the measurement target 200 by the illumination optical system 115. The illumination pattern 410 has a structure two-dimensionally and periodically divided by a large number of sections. The luminance of each section may have a physical meaning such as wavelet or Fourier, or may be random. In addition, a luminance distribution may be provided in the section.

The shift illumination pattern 420 is obtained by shifting the illumination pattern 410 by the pattern multiplexing unit 114. The shift amount corresponds to one section of the illumination pattern 410 in a direction α vertical to the movement of the measurement target 200 (hereinafter simply the vertical direction α). By setting the shift amount in this manner, each section in the vertical direction α of the shift illumination pattern 420 and each section in the vertical direction α of the illumination pattern 410 coincide with each other. Note that, since the condition is that the sections of the illumination pattern 410 of the shift illumination pattern 420 coincide with each other, the shift amount is not limited to one section and only needs to be an integer multiple thereof. In order to compensate for a shift in a direction horizontal to the movement of the measurement target 200 (hereinafter, simply the horizontal direction) due to the movement of the measurement target 200 during the switching, the shift illumination pattern 420 may have a shift amount in the horizontal direction that matches the movement distance of the measurement target 200.

The number of sections in the vertical direction α of the illumination pattern 410 is obtained by adding the shift amount (one section in the present embodiment) or more to the resolution in the vertical direction of an output image from the present device. Thus, it is also ensured that the measurement target 200 falls within the illumination pattern in the shift illumination pattern 420. Further, the number of sections in the horizontal direction of the illumination pattern 410 is sufficiently larger than the resolution in the horizontal direction of a finally output image. This is because the number of sections in the horizontal direction of the illumination pattern 410 corresponds to the number of illumination frames.

When an image with a resolution of 32×32 is output by the present device, the resolution of the illumination pattern 410 is, for example, 33×231. In this case, the number of illumination frames is 200.

The measurement target 200 is a target for image acquisition by the image acquiring device according to the present disclosure. The size of the measurement target 200 is smaller than the region of the illumination pattern corresponding to the output image from the device. For example, when an image with a resolution of 32×32 is output, the size is smaller than the range of 32×32 sections on the illumination pattern.

The object driving unit 300 has a function of moving the measurement target 200 at a constant speed. The moving direction 250 is vertical to the paper surface in FIG. 3. The object driving unit 300 is, for example, a belt conveyor used in a factory line.

The reception unit 130A receives light from the measurement target when the illumination pattern and the shift illumination pattern are irradiated onto the measurement target by the illumination system unit via a single pixel photodetector.

The reception unit 130A includes a reception optical system 131 and a single pixel photodetection unit 132.

The reception optical system 131 has a function of condensing the illumination pattern 410 or the shift illumination pattern 420 reflected and scattered by the measurement target 200 on the single pixel photodetection unit 132. “Reflection and scattering” represents reflection, scattering, or reflection and scattering. The reception optical system 131 is an imaging optical system including a lens and a mirror, and the shape and the number of lenses and mirrors are not limited.

The single pixel photodetection unit 132 has a function of converting light collected by the reception optical system 131 into an electric signal. A signal is acquired in a period equal to or less than half the time during which the measurement target 200 passes through one section of the illumination pattern 410. The single pixel photodetection unit 132 is a so-called photodetector, and for example, one made of Si in a visible wavelength band and one made of InGaAs or Ge in a short infrared wavelength band are generally used.

The signal processing unit 150A acquires a reception signal based on the light received by the reception unit 130A, and generates a two-dimensional image of the measurement target on the basis of a change in the reception signal when the measurement target passes on the illumination pattern and a change in the reception signal when the measurement target passes on the shift illumination pattern.

The signal processing unit 150A has a function of receiving the electric signal from the single pixel photodetection unit 132 and the timing signal from the illumination control unit 111A, and reconstructing the image of the measurement target 200.

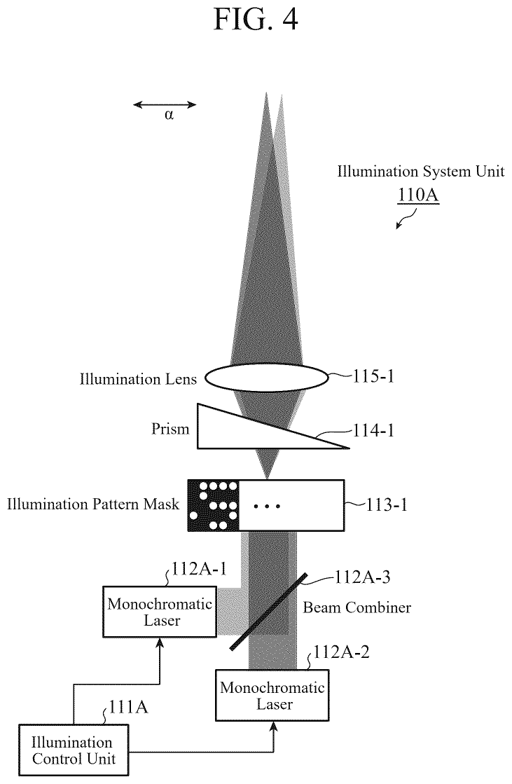

FIG. 4 is a diagram illustrating a configuration example of the illumination system unit 110A in the image acquiring device 100A according to the second embodiment of the present disclosure.

FIG. 4 is a diagram illustrating a specific configuration of the illumination system unit 110A, and the illumination system unit 110A includes an illumination control unit 111A, a monochromatic laser 112A-1, a monochromatic laser 112A-2, a beam combiner 112A-3, an illumination pattern mask 113-1, a prism 114-1, and an illumination lens 115-1.

The monochromatic laser 112A-1 and the monochromatic laser 112A-2 are laser light sources having different output wavelengths, and have a function of emitting light at a timing designated by the illumination control unit 111A. The wavelengths of the monochromatic laser 112A-1 and the monochromatic laser 112A-2 are set in such a manner that the illumination pattern generated by both lasers obtains a desired shift amount in consideration of the wavelength dispersion characteristic and the installation angle of the prism 114-1.

The beam combiner 112A-3 has a function of combining the light output from the monochromatic laser 112A-1 and the monochromatic laser 112A-2.

The illumination pattern mask 113-1 has a function of applying a spatial modulation pattern to the light from the beam combiner 112A-3. The illumination pattern mask 113-1 includes a large number of sections periodically arranged two-dimensionally, and for example, a small hole is opened at the center in some sections. Thus, a binary pattern such as 1 for a section with a small hole and 0 for a section without a small hole is given. Since such an illumination pattern mask 113-1 can be mass-produced by laser processing, the manufacturing cost is excellent.

The prism 114-1 has a function of separating propagation directions of light of the monochromatic laser 112A-1 and light of the monochromatic laser 112A-2. With this configuration, the illumination pattern 410 and the shift illumination pattern 420 can be switched with a configuration not including a mechanical driving unit.

The illumination lens 115-1 has a function of transferring the illumination pattern mask 113-1 onto the measurement target 200.

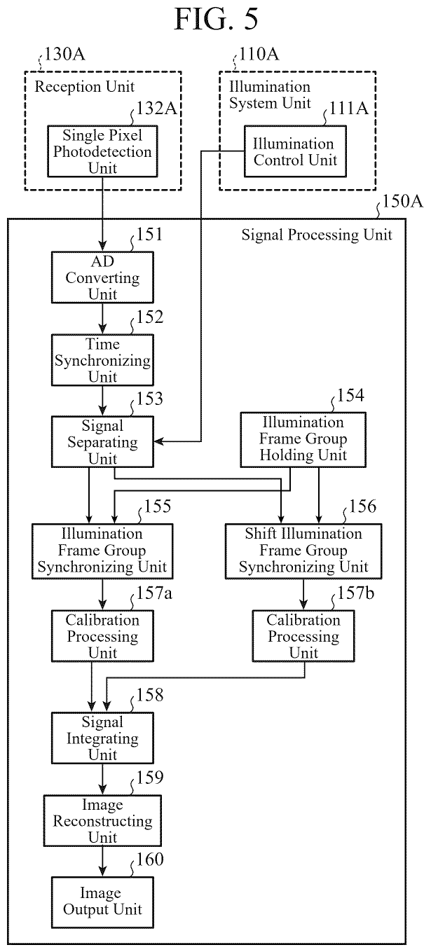

FIG. 5 is a diagram illustrating a configuration example of the signal processing unit 150A in the image acquiring device 100A according to the second embodiment of the present disclosure.

FIG. 5 is a configuration diagram of the signal processing unit 150A, and includes an AD converting unit 151, a time synchronizing unit 152, a signal separating unit 153, an illumination frame group holding unit 154, an illumination frame group synchronizing unit 155, a shift illumination frame group synchronizing unit 156, a calibration processing unit 157, a signal integrating unit 158, an image reconstructing unit 159, and an image output unit 160.

The AD converting unit 151 has a function of converting the electric signal from the single pixel photodetection unit 132 into a digital signal.

The time synchronizing unit 152 has a function of associating the reception signal from the AD converting unit 151 with the position of the measurement target 200 (illumination pixel number on the illumination pattern). For example, by assigning characteristic patterns to the left end and the right end of the illumination pattern 410 in the horizontal direction and identifying the timing of passing through the characteristic pattern in the reception signal, the time axis of the reception signal and the position of the measurement target 200 can be associated with each other.

The signal separating unit 153 has a function of determining and separating signals corresponding to the illumination pattern 410 and the shift illumination pattern 420 from the reception signal from the time synchronizing unit 152 using timing information from the illumination control unit 111. Furthermore, it also has a function of transmitting a portion corresponding to the illumination pattern 410 to the illumination frame group synchronizing unit 155 and a portion corresponding to the shift illumination pattern 420 to the shift illumination frame group synchronizing unit 156.

The illumination frame group holding unit 154 has a function of holding an illumination frame group corresponding to the illumination pattern 410 and the shift illumination pattern 420. The illumination frame is an apparent illumination pattern with which measurement target 200 is irradiated, and corresponds to an illumination pattern obtained by cutting out a range corresponding to the measurement target 200 from the illumination pattern. The illumination frame group is obtained by virtually moving the measurement target 200 by one section, taking out the illumination frame at each position of the measurement target 200, and putting the illumination frames together. For example, when the number of sections of the illumination pattern 410 is 33×301 and the size of the measurement target 200 corresponds to the number of sections 32×32, the illumination frame group has 270 illumination frames with a resolution of 32×32, and thus the illumination frame group has an array of 32×32×270.

The illumination frame group synchronizing unit 155 has a function of associating each point of the reception signal corresponding to the illumination pattern 410 with each illumination frame of the illumination frame group output from the illumination frame group holding unit 154.

The shift illumination frame group synchronizing unit 156 has a function of associating each point of the reception signal corresponding to the shift illumination pattern 420 with each illumination frame of the illumination frame group output from the illumination frame group holding unit 154.

The calibration processing unit 157 has a function of calibrating the reception signals output from the illumination frame group synchronizing unit 155 and the shift illumination frame group synchronizing unit 156. Specifically, it is removal of offset, correction when illumination power is different between the illumination pattern 410 and the shift illumination pattern 420, and the like.

The signal integrating unit 158 has a function of creating an integrated reception signal and an integrated illumination frame group by coupling the illumination frame group and the reception signal output from both the illumination frame group synchronizing unit 155 and the shift illumination frame group synchronizing unit 156.

The image reconstructing unit 159 has a function of applying image reconstruction processing to the integrated reception signal and the integrated illumination frame group output from the signal integrating unit 158 to generate a two-dimensional image of the measurement target 200.

The image output unit 160 has a function of outputting the image generated by the image reconstructing unit 159. The output destination is a display, an image inspection device, or the like.

### [Operation]

A processing example of the signal processing unit in the image acquiring device according to the second embodiment of the present disclosure will be described.

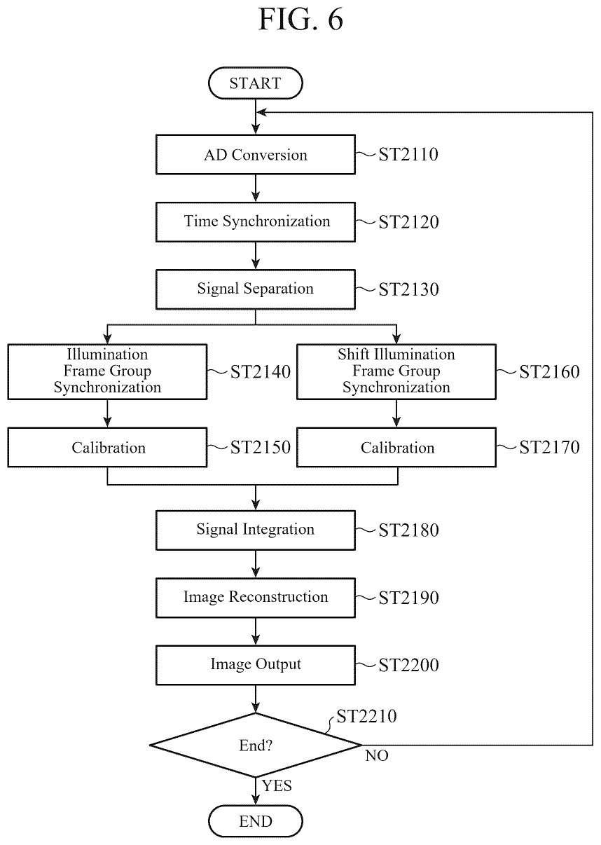

FIG. 6 is a flowchart illustrating a processing example of the signal processing unit 150A in the image acquiring device 100A according to the second embodiment of the present disclosure.

For example, the signal processing unit 150A starts processing upon receiving a signal from the reception unit 130A.

The signal processing unit 150A executes AD conversion processing (step ST2110).

In the AD conversion processing, the AD converting unit 151 of the signal processing unit 150A converts the electric signal from the single pixel photodetection unit 132 into a digital signal. The AD converting unit 151 outputs the digitized reception signal to the time synchronizing unit 152.

Next, the signal processing unit 150A executes time synchronization processing (step ST2120).

In the time synchronization processing, the time synchronizing unit 152 of the signal processing unit 150A associates the reception signal from the AD converting unit 151 with the position of the measurement target 200 (illumination pixel number on the illumination pattern).

Next, the signal processing unit 150A executes signal separation processing (step ST2130).

In the signal separation processing, the signal separating unit 153 of the signal processing unit 150A uses the timing information from the illumination control unit 111 to determine and separate signals corresponding to the illumination pattern 410 and the shift illumination pattern 420 from the reception signal from the time synchronizing unit 152.

Next, the signal processing unit 150A executes illumination frame group synchronization processing (step ST2140).

In the illumination frame group synchronization processing, the illumination frame group synchronizing unit 155 of the signal processing unit 150A associates each point of the reception signal corresponding to the illumination pattern 410 with each illumination frame of the illumination frame group output from the illumination frame group holding unit 154.

Next, the signal processing unit 150A executes calibration processing (step ST2150).

In the calibration processing, a calibration processing unit 157a of the signal processing unit 150A calibrates the reception signal output from the illumination frame group synchronizing unit 155. Specifically, the calibration processing unit 157a performs removal of the offset, correction when the illumination power is different between the illumination pattern 410 and the shift illumination pattern 420, and the like.

In addition, the signal processing unit 150A performs shift illumination frame group synchronization processing (step ST2160) in parallel with the illumination frame group synchronization processing.

In the shift illumination frame group synchronization processing, the shift illumination frame group synchronizing unit 156 of the signal processing unit 150A associates each point of the reception signal corresponding to the shift illumination pattern 420 with each illumination frame of the illumination frame group output from the illumination frame group holding unit 154.

Next, the signal processing unit 150A executes calibration processing (step ST2170).

In the calibration processing, a calibration processing unit 157b of the signal processing unit 150A has a function of calibrating the reception signal output from the shift illumination frame group synchronizing unit 156. Specifically, the calibration processing unit 157b performs removal of the offset, correction when the illumination power is different between the illumination pattern 410 and the shift illumination pattern 420, and the like.

Next, the signal processing unit 150A executes signal integration processing (step ST2180).

In the signal integration processing, the signal integrating unit 158 of the signal processing unit 150A couples the illumination frame group and the reception signal output from both the illumination frame group synchronizing unit 155 and the shift illumination frame group synchronizing unit 156, and creates an integrated reception signal and an integrated illumination frame group.

Next, the signal processing unit 150A executes image reconstruction processing (step ST2190).

In the image reconstruction processing, the image reconstructing unit 159 of the signal processing unit 150A applies the image reconstruction processing to the integrated reception signal and the integrated illumination frame group output from the signal integrating unit 158, and generates a two-dimensional image of the measurement target 200.

Next, the signal processing unit 150A executes image output processing (step ST2200).

In the image output processing, the image output unit 160 of the signal processing unit 150A outputs the image generated by the image reconstructing unit 159.

Next, the image acquiring device 100A proceeds to end determination processing (step ST2210).

In the end determination processing, a control unit not illustrated of the image acquiring device 100A determines whether to end the processing of the image acquiring device 100A. The control unit not illustrated determines whether to end the processing of the image acquiring device 100A in accordance with, for example, an external end command or an execution program.

When the control unit not illustrated determines not to end the processing of the image acquiring device 100A (step ST2210 “NO”), the process proceeds to the processing of step ST2110, and repetitive processing is performed from the processing of step ST2110.

When the control unit not illustrated determines to end the processing of the image acquiring device (step ST2210 “YES”), the image acquiring device ends the processing.

A processing example of the image acquiring device according to the second embodiment of the present disclosure will be described in more detail.

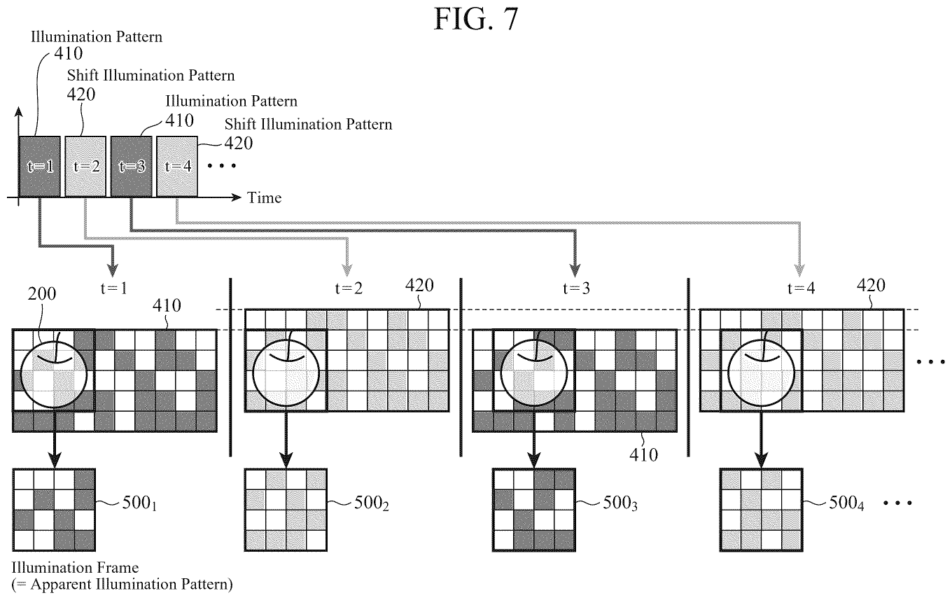

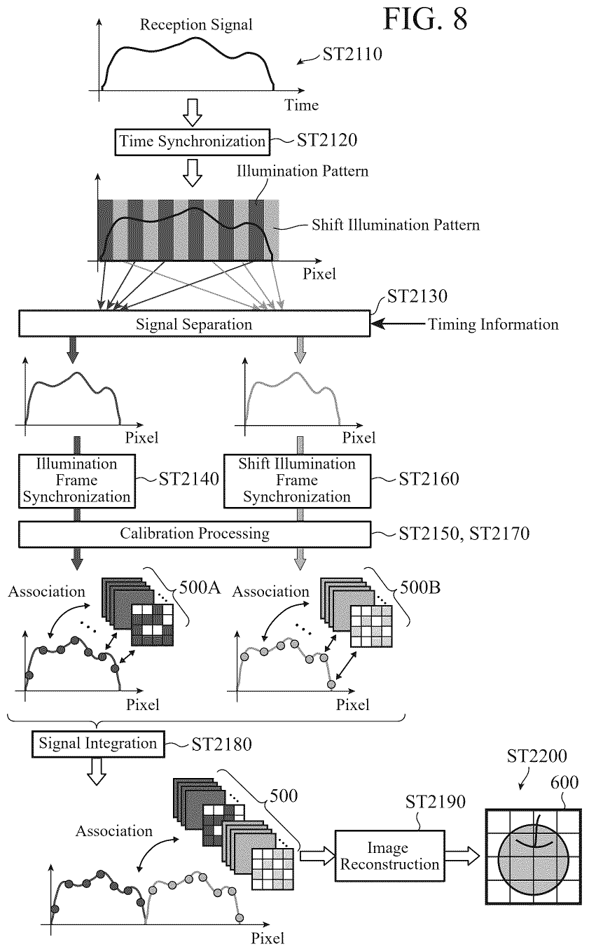

FIGS. 7 and 8 are operation explanatory diagrams of the first embodiment.

FIG. 7 is a diagram for describing an operation related to acquisition of a reception signal in the image acquiring device 100A according to the second embodiment of the present disclosure.

In accordance with the control from the illumination control unit 111, the illumination pattern 410 or the shift illumination pattern 420 is irradiated from the illumination system unit 110. The switching is periodic, and the illumination pattern 410 and the shift illumination pattern 420 are switched at regular time intervals. Here, the shift illumination pattern 420 is obtained by shifting the illumination pattern 410 by one section in the vertical direction α, but the pattern itself is the same. Since the shift is made by one section, the sections in the vertical direction α of the illumination pattern 410 and the shift illumination pattern 420 coincide with each other. That is, a relative position in a horizontal direction between the measurement target and the illumination pattern and a relative position in a horizontal direction between the measurement target and the shift illumination pattern do not change.

The measurement target 200 moves in the horizontal direction on the illumination pattern 410 or the shift illumination pattern 420. Then, the apparent illumination pattern (=illumination frame) with which the measurement target 200 is irradiated changes as the measurement target 200 moves. Even though the illumination pattern is single, the illumination frame changes, so that processing equivalent to general SPI can be performed.

Even if the position of the measurement target 200 is the same, since the apparent illumination pattern (=illumination frame) with which the measurement target 200 is irradiated is different between the illumination pattern 410 and the shift illumination pattern 420, it is possible to achieve twice the number of illumination frames as compared with the case of using only the illumination pattern 410. As described above, the shift illumination pattern 420 is merely obtained by shifting the illumination pattern 410, and only a single illumination pattern is used. Therefore, only one fixed pattern generating unit 113 is sufficient, and dynamic control and driving like a spatial light modulator are unnecessary.

Scattered light and reflected light at each position of the measurement target 200 are converted into continuous electric signals by the reception optical system 131 and the single pixel photodetection unit 132 and then transmitted to the signal processing unit 150A. The “reflected light and scattered light” represents reflected light, scattered light, or reflected light and scattered light.

FIG. 8 is a diagram for describing processing related to the signal processing unit 150A in the image acquiring device 100A according to the second embodiment of the present disclosure.

First, the AD converting unit 151 converts the electric signal from the single pixel photodetection unit 132 into a digital signal (step ST2110).

Next, the time synchronizing unit 152 associates the digital signal output from the AD converting unit 151 with the position of the measurement target 200 (=section number of illumination pattern 410) (step ST2120). Although the correspondence between the time axis of the signal and the position of the measurement target 200 is unknown at the time of output to the AD converting unit 151, for example, a characteristic pattern is given to the left end and the right end of the illumination pattern 410 in the horizontal direction, and the timing at which the measurement target 200 passes through the characteristic pattern is identified in the reception signal, whereby the time axis and the position of the measurement target 200 can be associated with each other.

Next, the signal separating unit 153 separates the output signal of the time synchronizing unit 152 into two parts of a part corresponding to the illumination pattern 410 and a part corresponding to the shift illumination pattern 420 (step ST2130). By using pattern switching timing information transmitted from the illumination control unit 111, it is possible to determine whether each region in the output signal corresponds to the illumination pattern 410 or the shift illumination pattern 420.

Two separation signals output from the signal separating unit 153 are associated with corresponding illumination frame groups by the illumination frame group synchronizing unit 155 and the shift illumination frame group synchronizing unit 156 (step ST2140 and step ST2160). Usually, the separation signal is a continuous signal, but only a data point (=hereinafter simply data point) corresponding to each illumination frame included in the illumination frame group is retrieved by synchronization with the illumination frame group, and becomes a discrete signal. At this time, for example, noise can be reduced by averaging points around corresponding data points.

Data points output from the illumination frame group synchronizing unit 155 and the shift illumination frame group synchronizing unit 156 are calibrated by the calibration processing unit 157 (step ST2150 and step ST2170). In addition to the removal of the offset, if there is a difference in the output power of the light source or the efficiency of the optical system because the wavelength is different between the illumination pattern 410 and the shift illumination pattern 420, the difference is corrected.

Illumination frame groups (500A and 500B) corresponding to the illumination pattern 410 and the shift illumination pattern 420 and the data points corresponding thereto output from the calibration processing unit 157 are integrated by the signal integrating unit 158 (step ST2180). Specifically, the illumination frame groups and the data points are connected to each other, and a new illumination frame group and a new data point are generated. By performing this processing, it is possible to obtain the illumination frame group and the data points twice as large as the case of using only the illumination pattern 410. This processing is possible because the sections of the illumination pattern 410 and the shift illumination pattern 420 coincide. Note that, when the sections do not match (=the shift amount is not an integer multiple of the section size), the position of the measurement target 200 is substantially shifted by one section or less between the illumination frame corresponding to the illumination pattern 410 and the illumination frame corresponding to the shift illumination pattern 420. As a result, problems such as failure in image reconstruction processing and blurring of the measurement target 200 in the output image occur.

In order to acquire an image with high accuracy by SPI, it is necessary to ensure a sufficient number of illumination frames. In the SPI using a single illumination pattern described in Non Patent Literature 2, since the number of illumination frames and the horizontal direction size of the illumination pattern are in a correspondence relationship, there is a problem that the horizontal direction size of the illumination pattern increases when an image is acquired with high accuracy. On the other hand, in the present disclosure, as described above, the substantial number of illumination frames can be increased by shifting the illumination pattern in the vertical direction while using a single illumination pattern. This makes it possible to acquire an image with high accuracy even when the size of the illumination pattern in the horizontal direction is reduced.

Using the illumination frame group newly generated by the signal integrating unit 158 and the data points corresponding thereto, the image reconstructing unit 159 reconstructs the image 600 of the measurement target 200 (step ST2190 and step ST2200). The process of image acquisition by SPI can be described as follows.

y=Ax (1)

Here, “y” in Formula (1) is a measurement value vector (N×1, data point corresponding to illumination frame group), “x” is a measurement target vector (M²×1, vectorized with rearranged elements of the measurement target 200 (resolution M×M)), and “A” is a measurement matrix (N×M²). Note that “N” is the number of illumination frames included in the illumination frame group, and “M” is the resolution of one side of the measurement target 200. When the illumination frame is set as I₁, I₂, . . . , I_{N}, the measurement matrix A can be expressed by the following Formula (2).

A=[vec[I₁] vec[I₂] . . . vec[I_{N}]]^{t} (2)

Here, in Formula (2), “vec[ ]” represents an operator that rearranges and vectorizes elements of a matrix, and “[ ]^{t}” represents transposition. In SPI, it is necessary to solve an inverse problem of estimating “x” that is the measurement target using known “y” and “A”.

As a method for solving the above, a method similar to ghost imaging for obtaining a correlation between a data point and a frame group, a method similar to compression sensing in which the above formula is used as an optimization problem, and the like are known. The compression sensing method has a feature that an image of a measurement target can be reproduced even under a condition where a data point is limited such as N<M², and is particularly effective in a configuration as in the present disclosure in which the number of data points (=the number of illumination frames) is limited by the illumination pattern size.

### Effects According to Second Embodiment

By configuring as in the present embodiment, since the number of illumination frames is doubled, the size of the illumination pattern in the horizontal direction can be reduced, and the device size can be reduced.

Since the above can be performed with only a single illumination pattern, the pattern generating unit that generates the illumination pattern can be configured without dynamic drive and control like the spatial light modulator. In addition, the number of illumination frames is doubled with a configuration that does not require a mechanical driving unit, which contributes to downsizing, cost reduction, and high reliability of the device.

The number of illumination frames can be increased by using, for example, two types of pattern generators that generate different illumination patterns, but according to the present embodiment, since one pattern generator can be used, the device configuration can be simplified as compared with the above configuration.

The image acquiring device of the present disclosure according to the present embodiment is further configured as follows, for example.

The image acquiring device, in which
the illumination system unit includes:
a light source unit;
a pattern generating unit to apply a two-dimensional pattern to light emitted from the light source unit;
an illumination optical system to project the light to which the two-dimensional pattern is applied by the pattern generating unit onto a measurement target; and
an illumination pattern shift unit to shift an illumination pattern generated by the illumination optical system,
the pattern generating unit is configured by a static structure that applies the two-dimensional pattern that is single to the light emitted from the light source unit, and
the illumination system unit emits the illumination pattern and one or more shift illumination patterns obtained by shifting the illumination pattern by the illumination pattern shift unit while switching the illumination pattern and the one or more shift illumination patterns depending on a lapse of time.

### [Other Modifications]

The pattern multiplexing unit 114 may be disposed between the reception optical system 131 and the single pixel photodetection unit 132. Even in this case, functions and effects equivalent to those of the present embodiment can be obtained. Furthermore, a relay optical system may be inserted between the pattern multiplexing unit 114 and the single pixel photodetection unit 132.

For switching between the illumination pattern 410 and the shift illumination pattern 420, not only the wavelength of light but also polarized light of light can be used. For example, the time-multiplexed light source unit 112 includes a laser light source and a polarization switch, the pattern multiplexing unit 114 includes an element (birefringent crystal) that gives a different refraction angle depending on polarization, and the illumination control unit 111 performs control to switch the polarization of the output light from the time-multiplexed light source unit 112, thereby obtaining functions and effects equivalent to those of the present embodiment.

The shift direction of the shift illumination pattern 420 need not be the vertical direction. In a case where a shift vector expressing a shift magnitude and direction is defined, a vertical component of the vector is set to the integer multiple of the section, and a horizontal component of the vector is set to the size corresponding to the movement amount of the measurement target 200, so that the shift caused by the movement of the measurement target 200 in the horizontal direction while the illumination pattern is shifted can be compensated.

A mechanism that can easily adjust the shift direction of the shift illumination pattern 420 may be provided. This can be implemented, for example, by attaching, to the outside of the housing of the illumination system unit 110, a mechanism capable of adjusting the inclination angle and the rotation angle around the optical axis of the wavelength dispersion element inside the pattern multiplexing unit 114. Since the moving speed of the measurement target 200 may be different depending on the installation environment, it is possible to cope with any moving speed of the measurement target 200 by including the above mechanism.

### Third Embodiment

A third embodiment will be described.

In the third embodiment, among the components according to the third embodiment, components similar to the components according to the first embodiment or the second embodiment already described are denoted by similar names and similar reference numerals, and redundant description is appropriately omitted.

### [Configuration]

A configuration example of an image acquiring device according to the third embodiment of the present disclosure will be described.

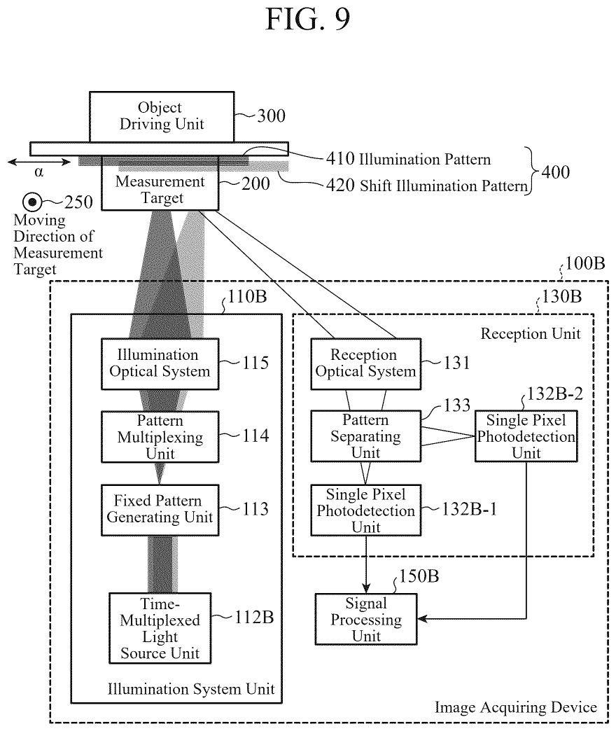

FIG. 9 is a diagram illustrating a configuration example of an image acquiring device 100B according to the third embodiment of the present disclosure and a configuration example in a case where the image acquiring device 100B is applied to a measurement system.

Hereinafter, the same components as those in the first and second embodiments will be denoted by the same names and the same or similar reference numerals, and the configuration will be described focusing on differences from the first and second embodiments.

The image acquiring device 100B illustrated in FIG. 9 includes an illumination system unit 110B, a reception unit 130B, and a signal processing unit 150B.

The illumination system unit 110B in the image acquiring device 100B includes an illumination control unit 111B, a time-multiplexed light source unit 112B, a fixed pattern generating unit 113, a pattern multiplexing unit 114, and an illumination optical system 115.

The illumination system unit 110B simultaneously irradiates the illumination pattern and one or more shift illumination patterns obtained by shifting the illumination pattern by the illumination pattern shift unit (fixed pattern generating unit 113).

The time-multiplexed light source unit 112B has a function of always irradiating the fixed pattern generating unit 113 with two light beams having different wavelengths.

The time-multiplexed light source unit 112B constitutes a light source unit of the present disclosure.

The fixed pattern generating unit 113 has a function of applying a spatial modulation pattern to the light irradiated from the time-multiplexed light source unit 112B.

The fixed pattern generating unit 113 constitutes a pattern generating unit of the present disclosure.

The pattern generating unit (fixed pattern generating unit 113) applies a two-dimensional pattern to light emitted from the light source unit (time-multiplexed light source unit 112B).

The pattern generating unit (fixed pattern generating unit 113) has a static structure that applies the single two-dimensional pattern to the light emitted from the light source unit (time-multiplexed light source unit 112B).

The pattern multiplexing unit 114 has a function of simultaneously generating the illumination pattern 410 and the shift illumination pattern 420 obtained by shifting the illumination pattern 410 in accordance with the wavelength of light by imparting refraction depending on the wavelength to the light passing through the fixed pattern generating unit 113.

The pattern multiplexing unit 114 constitutes an illumination pattern shift unit of the present disclosure.

The illumination pattern shift unit (pattern multiplexing unit 114) shifts the illumination pattern generated by the illumination optical system. The illumination pattern shift unit (pattern multiplexing unit 114) simultaneously generates and outputs the illumination pattern 410 and the shift illumination pattern 420.

The pattern generating unit (pattern multiplexing unit 114) has a static structure that applies the single two-dimensional pattern to the light emitted from the light source unit (time-multiplexed light source unit 112B).

The illumination optical system 115 projects the light to which the two-dimensional pattern is applied by the pattern generating unit (pattern multiplexing unit 114) onto the measurement target.

The reception unit 130B includes a reception optical system 131, a single pixel photodetection unit 132B-1, a single pixel photodetection unit 132B-2, and a pattern separating unit 133.

The reception optical system 131 has a function of transmitting the illumination pattern 410 and the shift illumination pattern 420 reflected and scattered by the measurement target 200 to the pattern separating unit 133.

The pattern separating unit 133 has a function of separating and transmitting the illumination pattern 410 to the single pixel photodetection unit 132B-1 and the shift illumination pattern 420 to the single pixel photodetection unit 132B-2 depending on the wavelength of incident light. Specifically, it is configured by a beam splitter or the like having transmission characteristics/reflection characteristics depending on a wavelength.

The single pixel photodetection unit 132B-1 and the single pixel photodetection unit 132B-2 have a function of converting the light transmitted from the pattern separating unit 133 into an electric signal. The single pixel photodetection unit 132B-1 and the single pixel photodetection unit 132B-2 are so-called photodetection units, and those made of Si are generally used in the visible wavelength band, and those made of InGaAs or Ge are generally used in the short infrared wavelength band.

That is, the reception unit 130B of the present disclosure includes a plurality of the single pixel photodetectors (the single pixel photodetection unit 132B-1 and the single pixel photodetection unit 132B-2) that receives light from the measurement target when the illumination pattern and the shift illumination pattern are irradiated onto the measurement target by the illumination system unit 110B.

The plurality of single pixel photodetectors detects the illumination pattern and the shift illumination pattern separately.

The signal processing unit 150B has a function of receiving electric signals from the single pixel photodetection unit 132B-1 and the single pixel photodetection unit 132B-2, and reproducing (“reproduction” is also described as “generation” or “reconstruction”) and outputting an image of the measurement target 200.

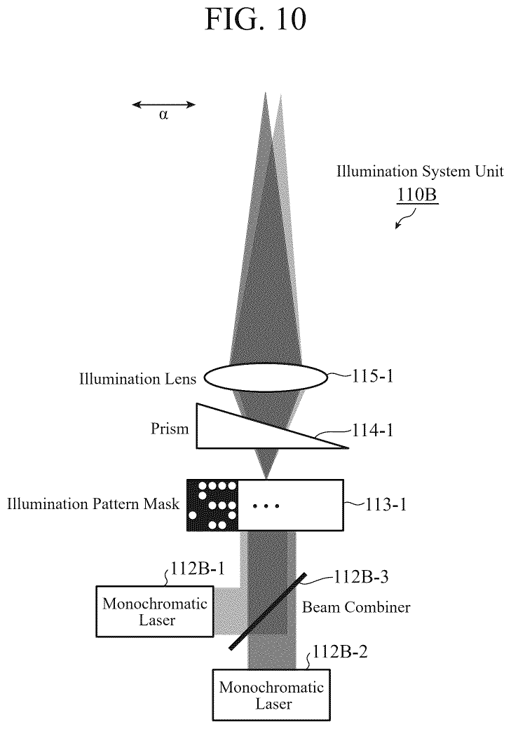

FIG. 10 is a diagram illustrating a configuration example of the illumination system unit 110B in the image acquiring device 100B according to the third embodiment of the present disclosure.

Hereinafter, the same components as those in the first and second embodiments will be denoted by the same names and the same or similar reference numerals, and the configuration will be described focusing on differences from the first and second embodiments.

A monochromatic laser 112B-1 and a monochromatic laser 112B-2 are laser light sources having different output wavelengths, and continuously output light.

A beam combiner 112B-3 has a function of combining the light output from the monochromatic laser 112B-1 and the monochromatic laser 112B-2.

The prism 114-1 has a function of separating propagation directions of light of the monochromatic laser 112B-1 and light of the monochromatic laser 112B-2. With this configuration, the illumination pattern 410 and the shift illumination pattern 420 can be simultaneously generated.

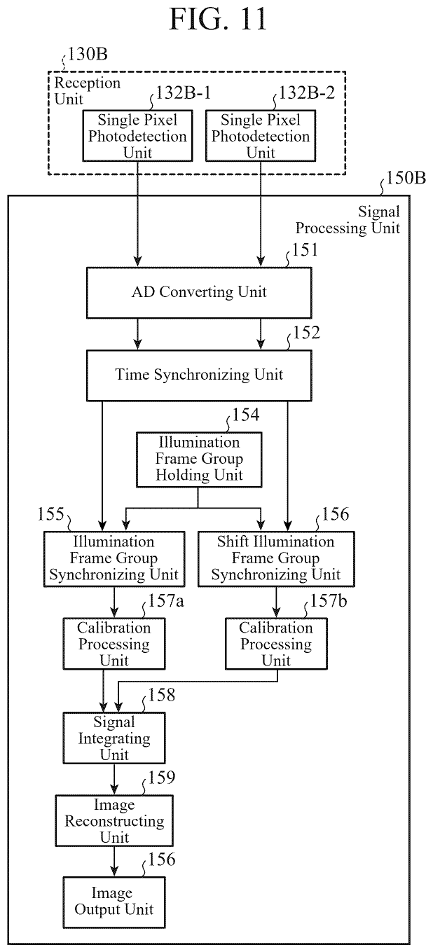

FIG. 11 is a diagram illustrating a configuration example of the signal processing unit 150B in the image acquiring device 100B according to the third embodiment of the present disclosure.

Hereinafter, components similar to those in the first and second embodiments are denoted by the same names and the same or similar reference numerals, and the configuration will be described focusing on differences from the first and second embodiments.

The AD converting unit 151 has a function of converting electric signals from the single pixel photodetection unit 132B-1 and the single pixel photodetection unit 132B-2 into digital signals.

The illumination frame group synchronizing unit 155 has a function of associating each point of the reception signal corresponding to the illumination pattern 410 output from the time synchronizing unit 152 with each illumination frame of the illumination frame group output from the illumination frame group holding unit 154.

The shift illumination frame group synchronizing unit 156 has a function of associating each point of the reception signal corresponding to the shift illumination pattern 420 output from the time synchronizing unit 152 with each illumination frame of the illumination frame group output from the illumination frame group holding unit 154.

### [Operation]

A processing example of the image acquiring device according to the third embodiment of the present disclosure will be described.

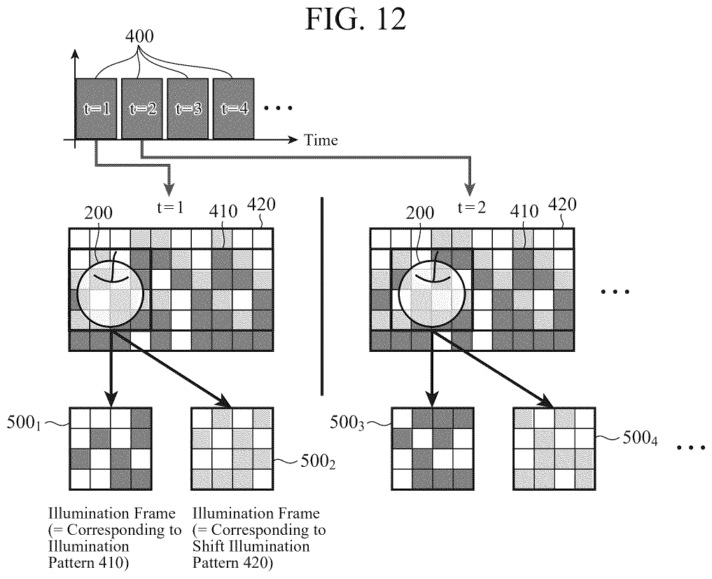

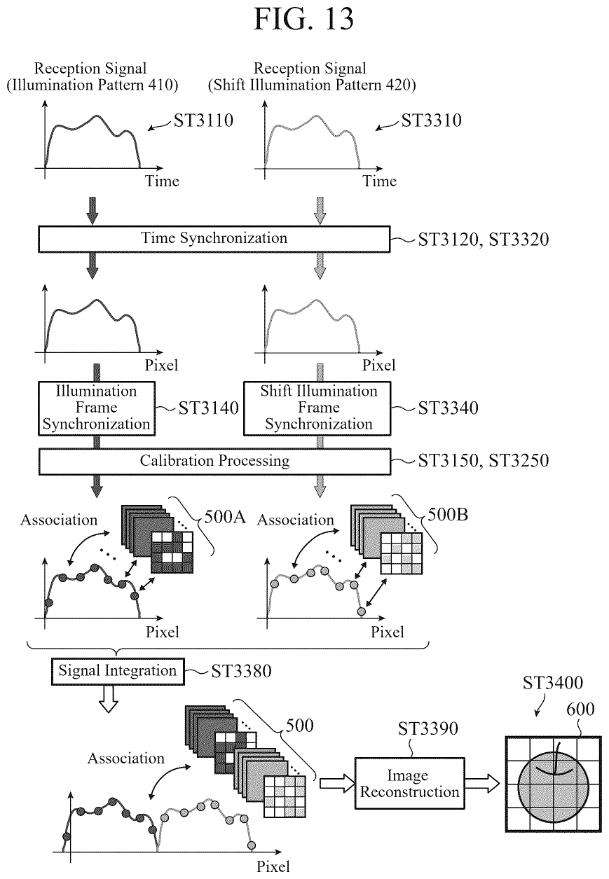

FIGS. 12 and 13 are operation explanatory diagrams of the second embodiment. Hereinafter, the same components as those in the first and second embodiments will be denoted by the same names and the same or similar reference numerals, and the configuration will be described focusing on differences from the first and second embodiments.

FIG. 12 is a diagram for describing an operation related to acquisition of a reception signal in the image acquiring device 100B according to the third embodiment of the present disclosure.

The difference from the second embodiment is only that the illumination pattern 410 and the shift illumination pattern 420 are simultaneously irradiated from the illumination system unit 110B. Scattered light and reflected light from the illumination pattern 410 at each position of the measurement target 200 are converted into continuous electrical signals by the single pixel photodetection unit 132B-1, and scattered light and reflected light from the shift illumination pattern 420 are converted into continuous electrical signals by the single pixel photodetection unit 132B-2, and are transmitted to the signal processing unit 150B.

In addition, since the illumination pattern 410 and the shift illumination pattern 420 are simultaneously irradiated, it is not necessary to consider the shift of the shift illumination pattern 420 in the horizontal direction for compensating the movement of the measurement target 200.

FIG. 13 is a diagram for describing processing related to the signal processing unit 150B in the image acquiring device 100B according to the third embodiment of the present disclosure.

The difference from the second embodiment is only that, since the reception signal is separated into the reception signals corresponding to the illumination pattern 410 and the shift illumination pattern 420 at the time of being input to the signal processing unit 150B, there is no processing corresponding to the signal separating unit 153 or timing synchronization processing by the illumination control unit 111, and processing corresponding to the AD converting unit 151 and the time synchronizing unit 152 is performed on each reception signal.

Therefore, a detailed description of the processing of steps ST3310 to ST3400 illustrated in FIG. 13 will be omitted.

### Effects According to Third Embodiment

By configuring as in the present embodiment, it is not necessary to synchronize pattern switching timings as compared with the first embodiment, and thus there is an advantage that signal processing becomes easy.

Further, since both patterns are continuously irradiated at the same time, there are advantages that the exposure time is easily increased and the signal-to-noise ratio is also improved.

In addition, since the illumination pattern 410 and the shift illumination pattern 420 are simultaneously irradiated, it is not necessary to consider the shift of the shift illumination pattern 420 in the horizontal direction for compensating the movement of the measurement target 200.

The image acquiring device of the present disclosure according to the present embodiment is further configured as follows, for example.

The image acquiring device according to claim 1, in which
the illumination system unit includes:
a light source unit;
a pattern generating unit to apply a two-dimensional pattern to light emitted from the light source unit;
an illumination optical system to project the light to which the two-dimensional pattern is applied by the pattern generating unit onto a measurement target; and
an illumination pattern shift unit to shift an illumination pattern generated by the illumination optical system,
the reception unit includes a plurality of single pixel photodetectors, which is included in the single pixel photodetector, to receive light from the measurement target when the illumination pattern and the shift illumination pattern are irradiated onto the measurement target by the illumination system unit,
the pattern generating unit is configured by a static structure that applies the two-dimensional pattern that is single to the light emitted from the light source unit,
the illumination system unit simultaneously irradiates the illumination pattern and one or more shift illumination patterns obtained by shifting the illumination pattern by the illumination pattern shift unit, and
the plurality of single pixel photodetectors separately detect the illumination pattern and the shift illumination patterns.

Thus, the present disclosure has an effect of providing an image acquiring device that does not need to synchronize pattern switching timing.

Furthermore, the present disclosure achieves an effect similar to the above effect by applying the above configuration to the above image acquiring method.

### [Other Modifications]

As in the second embodiment, the pattern multiplexing unit 114 may be disposed after the reception optical system 131.

As in the second embodiment, instead of the wavelength of light, polarized light can also be used to generate the shift illumination pattern 420. For example, by configuring the time-multiplexed light source unit 112B with two laser light sources having orthogonal polarizations, the pattern multiplexing unit 114 with elements (birefringent crystals) that give different refractive angles depending on polarization, and the pattern separating unit 133 with a polarization beam splitter or the like, functions and effects equivalent to those of the present embodiment can be obtained.

### Fourth Embodiment

A fourth embodiment will be described.

In the fourth embodiment, among the components according to the fourth embodiment, components similar to the components according to the first embodiment, the second embodiment, or the third embodiment already described are denoted by similar names and similar reference numerals, and redundant description is appropriately omitted.

### [Configuration]

A configuration example of an image acquiring device according to the fourth embodiment of the present disclosure will be described.

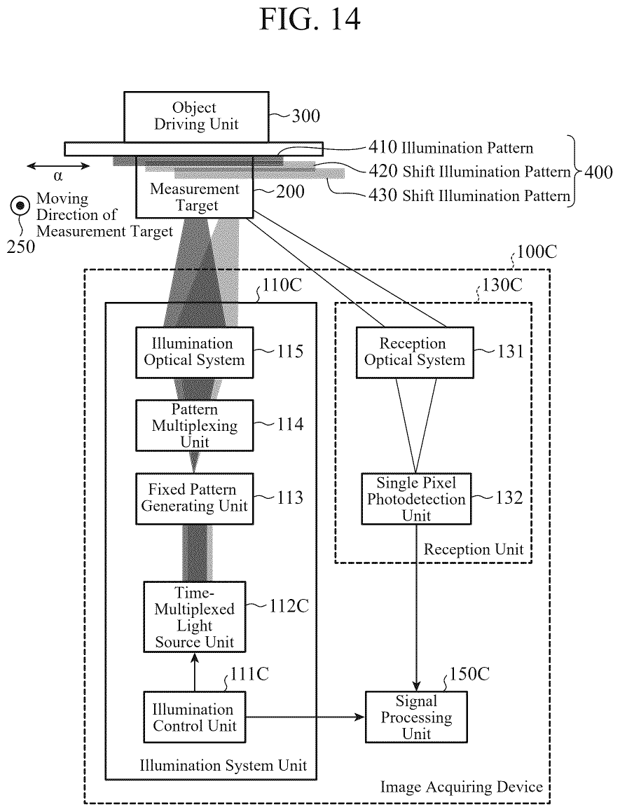

FIG. 14 is a diagram illustrating a configuration example of an image acquiring device 100C according to the fourth embodiment of the present disclosure and a configuration example in a case where the image acquiring device 100C is applied to a measurement system.

Hereinafter, the same components as those in the first, second, and third embodiments will be denoted by the same names and the same or similar reference numerals, and the configuration will be described focusing on differences from the first, second, and third embodiments.

The time-multiplexed light source unit 112C has a function of irradiating the fixed pattern generating unit 113 with three light beams having different wavelengths while temporally switching between them on the basis of the control from the illumination control unit 111C.

The pattern multiplexing unit 114 has a function of switching the modulation pattern transferred to the measurement target 200 to one of the illumination pattern 410, the shift illumination pattern 420 (second illumination pattern and first shift illumination pattern), and the shift illumination pattern 430 (third illumination pattern and second shift illumination pattern) depending on the wavelength of the light by imparting refraction depending on the wavelength to the light passing through the fixed pattern generating unit 113. Note that, here, the number of illumination patterns is three types for convenience, but as illustrated in the specific configuration of the illumination system unit 110C, four types or more can be used.

The shift illumination pattern 430 is obtained by shifting the illumination pattern 410 in a direction vertical to the movement of the measurement target 200 (hereinafter simply referred to as the vertical direction) by the pattern multiplexing unit 114. Here, two sections of the illumination pattern 410 are assumed as the shift amount. By setting the shift amount in this manner, sections in the vertical direction of the shift illumination pattern 430, the shift illumination pattern 420, and the illumination pattern 410 coincide with each other. Note that since it is important that the sections in the vertical direction of the three illumination patterns coincide with each other, the shift amount of the shift illumination pattern 430 and the shift illumination pattern 420 only needs to be an integer multiple of the section size, and is not limited to two sections.

The number of sections in the vertical direction of the illumination pattern 410 is obtained by adding the shift amount (two sections in the present embodiment) or more to the number of pixels in the vertical direction of the output image from the present device. Thus, it is also ensured that the measurement target 200 falls within the illumination pattern in the shift illumination pattern 430. When an image with a resolution of 32×32 is output by the present device, the resolution of the illumination pattern 410 is, for example, 34×231. In this case, the number of illumination frames is 200.

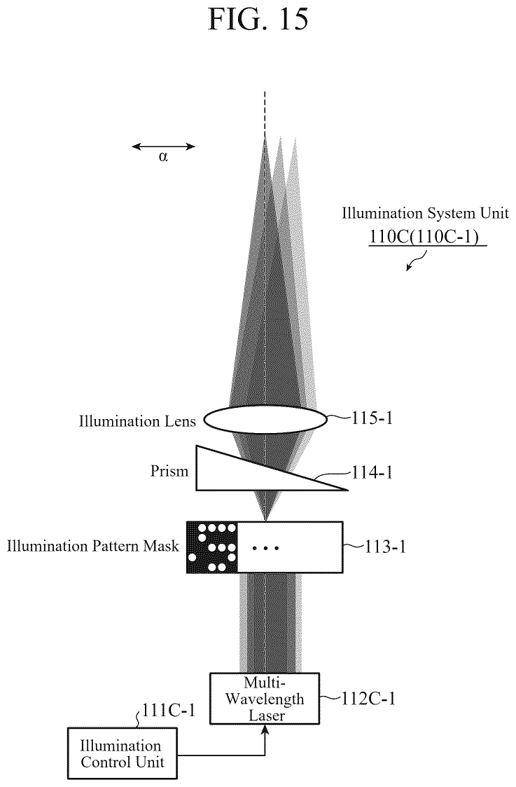

FIG. 15 is a diagram illustrating a first configuration example of an illumination system unit 110C in the image acquiring device 100C according to the fourth embodiment of the present disclosure.

Hereinafter, the same components as those in the first, second, and third embodiments will be denoted by the same names and the same or similar reference numerals, and the configuration will be described focusing on differences from the first, second, and third embodiments.

A multi-wavelength laser 112C-1 is a laser light source capable of outputting light of three or more different wavelengths, and has a function of emitting light at a wavelength designated at a timing designated by the illumination control unit 111C.

The prism 114-1 has a function of separating a propagation direction of light depending on a wavelength of output light of the multi-wavelength laser 112C-1. With this configuration, the illumination pattern 410, the shift illumination pattern 420, and the shift illumination pattern 430 can be switched in a configuration not including a mechanical driving unit.

It is also possible to implement four or more kinds of illumination patterns by changing a control signal to the multi-wavelength laser 112C-1 output from the illumination control unit 111C.

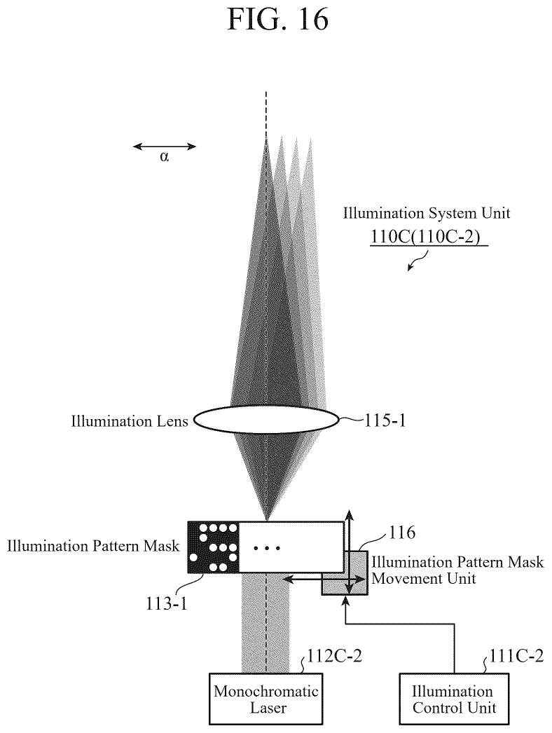

FIG. 16 is a diagram illustrating a second configuration example of an illumination system unit 110C in the image acquiring device 100C according to the fourth embodiment of the present disclosure.

Hereinafter, the same components as those in the first, second, and third embodiments will be denoted by the same names and the same or similar reference numerals, and the configuration will be described focusing on differences from the first, second, and third embodiments.

A monochromatic laser 112C-2 is a laser light source having a single output wavelength, and continuously outputs light.

The illumination pattern mask 113-1 has a function of applying a spatial modulation pattern to the light from the monochromatic laser 112C-2.

An illumination pattern mask moving unit 116 has a function of moving the illumination pattern mask 113-1 in one axis or two axes in accordance with a control signal from the illumination control unit 111C-2. With this configuration, the illumination pattern 410, the shift illumination pattern 420, and the shift illumination pattern 430 can be switched. The illumination pattern mask moving unit 116 may be configured to be controllable from the outside of the image acquiring device 100C, for example.

The illumination pattern mask moving unit 116 constitutes a pattern moving unit of the present disclosure.

The pattern moving unit (illumination pattern mask moving unit 116) changes a shift direction of the shift illumination pattern.

It is also possible to implement four or more kinds of illumination patterns by changing the control signal to the illumination pattern mask moving unit 116 output from the illumination control unit 111C-2.

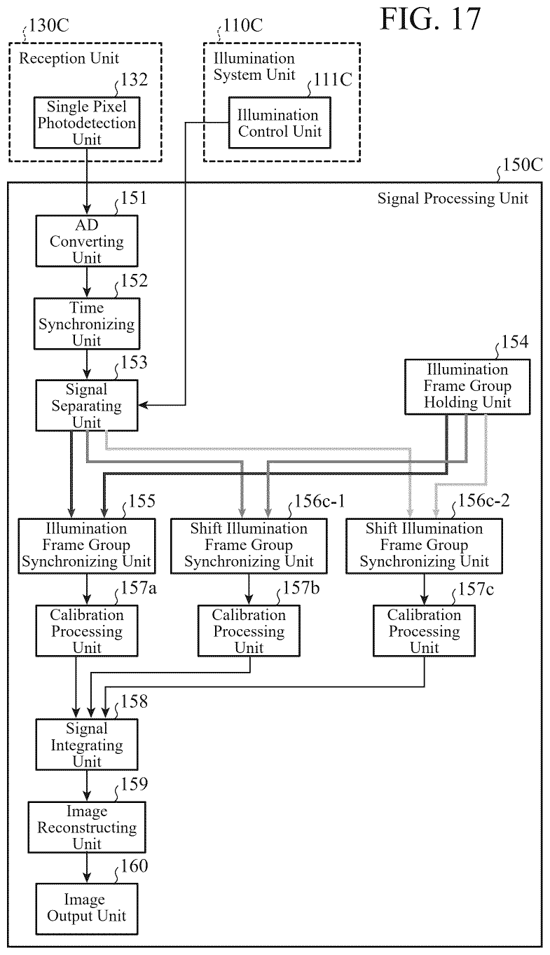

FIG. 17 is a diagram illustrating a configuration example of the signal processing unit 150C in the image acquiring device 100C according to the fourth embodiment of the present disclosure.

Hereinafter, the same components as those in the first, second, and third embodiments will be denoted by the same names and the same or similar reference numerals, and the configuration will be described focusing on differences from the first, second, and third embodiments.

The signal separating unit 153 has a function of determining and separating signals corresponding to the illumination pattern 410, the shift illumination pattern 420, and the shift illumination pattern 430 from the reception signal from the time synchronizing unit 152 using the timing information from the illumination control unit 111. Furthermore, it also has a function of transmitting a portion corresponding to the illumination pattern 410 to the illumination frame group holding unit 154, a portion corresponding to the shift illumination pattern 420 to the shift illumination frame group synchronizing unit 156C-1, and a portion corresponding to the shift illumination pattern 430 to the shift illumination frame group synchronizing unit 156C-2.

The illumination frame group holding unit 154 has a function of holding the illumination frame group of the shift illumination pattern 430 corresponding to the illumination pattern 410 and the shift illumination pattern 420.

Similarly to the shift illumination frame group synchronizing unit 156, the shift illumination frame group synchronizing unit 156C-1 has a function of associating each point of the reception signal corresponding to the shift illumination pattern 420 output from the time synchronizing unit 152 with each illumination frame of the illumination frame group output from the illumination frame group holding unit 154.

The shift illumination frame group synchronizing unit 156C-2 has a function of associating each point of the reception signal corresponding to the shift illumination pattern 430 with each illumination frame of the illumination frame group output from the illumination frame group holding unit 154.

The calibration processing unit 157 has a function of calibrating the reception signals output from the illumination frame group holding unit 154, the shift illumination frame group synchronizing unit 156C-1, and the shift illumination frame group synchronizing unit 156C-2. Specifically, this includes removal of the offset, correction when the illumination power varies in each pattern, and the like.

The signal integrating unit 158 couples the illumination frame groups and the reception signals output from the illumination frame group holding unit 154, the shift illumination frame group synchronizing unit 156C-1, and the shift illumination frame group synchronizing unit 156C-2, respectively, and creates an integrated reception signal and an integrated illumination frame group.

### [Operation]

A processing example of the image acquiring device according to the fourth embodiment of the present disclosure will be described.

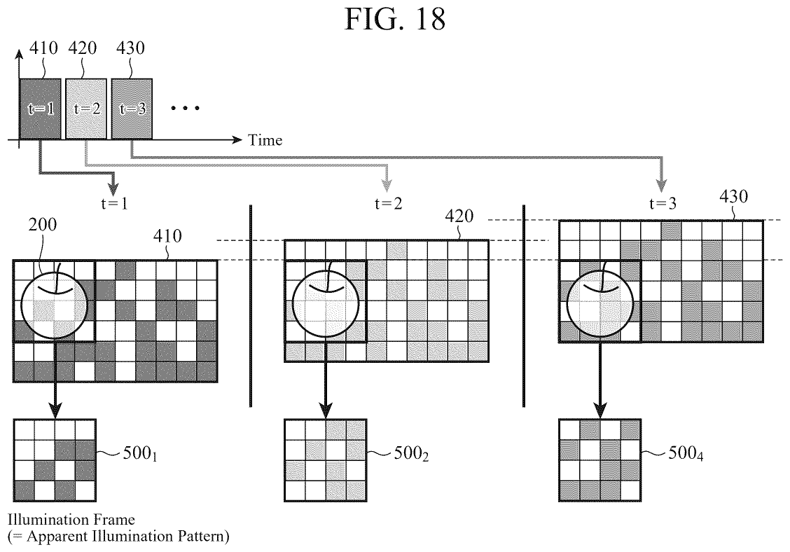

FIG. 18 is a diagram for describing an operation related to acquisition of a reception signal in the image acquiring device 100C according to the fourth embodiment of the present disclosure.

Hereinafter, the configuration will be described focusing on differences from the first, second, and third embodiments.

A difference from the other embodiments is that the number of patterns output from the illumination system unit 110C is increased. Scattered light and reflected light corresponding to the illumination pattern 410, the shift illumination pattern 420, and the shift illumination pattern 430 are irradiated. The scattered light and the reflected light from the illumination pattern 410 are converted into continuous electrical signals by the single pixel photodetection unit 132, and the scattered light and the reflected light from the shift illumination pattern 420 are converted into continuous electrical signals by the single pixel photodetection unit 132B-2, and are transmitted to the signal processing unit 150C. In the signal processing unit 150C, processing similar to that of the second embodiment is performed after each illumination pattern is separated.

### Effects According to Fourth Embodiment

By configuring as in the present embodiment, the substantial number of illumination frames is tripled, so that the size of the illumination pattern in the horizontal direction can be further reduced.

In addition, the number of illumination patterns can be increased to four or more only by changing the signal from the illumination control unit 111 without changing the device configuration.

When the illumination system unit 110 is configured as illustrated in FIG. 15, the illumination pattern can be shifted without including a mechanical driving unit. This contributes to cost reduction, miniaturization, and high reliability of the device.

In the case of configuring the illumination system unit 110 as illustrated in FIG. 16, since the prism 114-1 can be removed, the optical system can be simplified. Furthermore, in a case where the illumination pattern mask moving unit 116 is driven by two axes, there is an advantage that the inclination angle in the shift direction of the illumination pattern can be adjusted only by changing the control signal to the illumination pattern mask moving unit 116.

The image acquiring device of the present disclosure according to the present embodiment is further configured as follows, for example.

An image acquiring device including a pattern moving unit to change a shift direction of the shift illumination pattern.

### [Other Modifications]

When the illumination system unit 110 is configured as illustrated in FIG. 15, the multi-wavelength laser 112C-1 may have a function of continuously changing the output wavelength. In that case, since the positions of the shift illumination pattern 420 and the shift illumination pattern 430 can be changed by finely adjusting the output wavelength, there is an advantage that the requirement for the installation accuracy of the pattern multiplexing unit 114 can be lowered.

### Fifth Embodiment

A fifth embodiment will be described.

In the fifth embodiment, among the components according to the fifth embodiment, components similar to the components according to the first embodiment, the second embodiment, the third embodiment, or the fourth embodiment already described are denoted by similar names and similar reference numerals, and redundant description is appropriately omitted.

### [Configuration]

A configuration example of an image acquiring device according to the fifth embodiment of the present disclosure will be described.

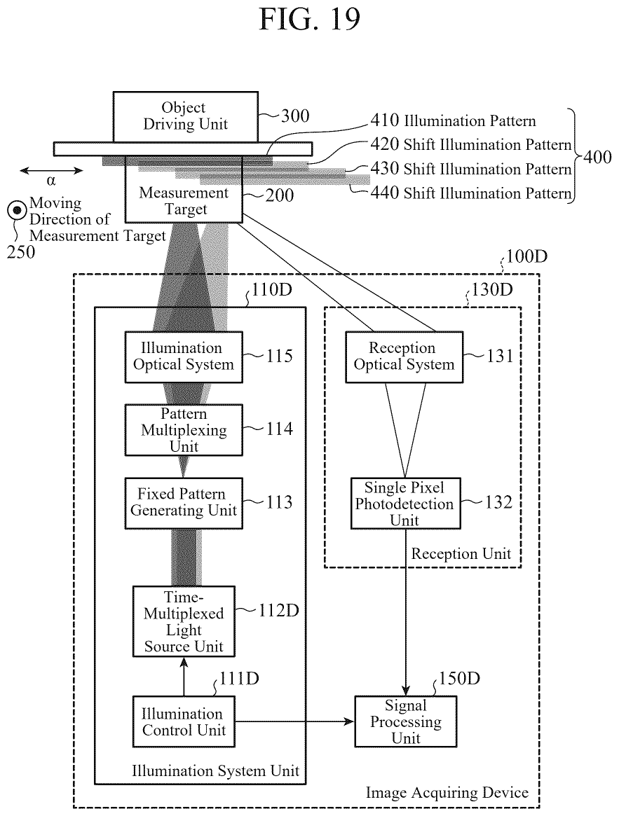

FIG. 19 is a diagram illustrating a configuration example of an image acquiring device 100D according to the fifth embodiment of the present disclosure and a configuration example in a case where the image acquiring device 100D is applied to a measurement system.

Hereinafter, the same components as those in the first, second, third, and fourth embodiments will be denoted by the same names and the same or similar reference numerals, and the configuration will be described focusing on differences from the first, second, third, and fourth embodiments.

The image acquiring device 100D irradiates the measurement target 200 with four of an illumination pattern 410, a shift illumination pattern 420 (second illumination pattern and first shift illumination pattern), a shift illumination pattern 430 (third illumination pattern and second shift illumination pattern), and a shift illumination pattern 440 (fourth illumination pattern and third shift illumination pattern). The shift illumination pattern 420, the shift illumination pattern 430, and the shift illumination pattern 440 are shifted from the illumination pattern 410 at equal intervals, where the shift interval is half of the section of the illumination pattern 410. Therefore, the shift illumination pattern 420, the shift illumination pattern 430, and the shift illumination pattern 440 are obtained by shifting the illumination pattern 410 by 1/2, 1, and 3/2 in the vertical direction.

The single pixel photodetection unit 132 has a function of converting the light collected by the reception optical system 131 into an electrical signal, and acquires a signal at an interval of 1/8 of the time during which the measurement target 200 passes through one pixel of the illumination pattern 410. Thus, a signal is acquired not only when the measurement target 200 is on the illumination pattern 410, the shift illumination pattern 420, the shift illumination pattern 430, and the shift illumination pattern 440 (hereinafter referred to as cases 1 to 4), but also when the measurement target 200 is shifted by 1/2 in the horizontal direction from the illumination pattern 410, the shift illumination pattern 420, the shift illumination pattern 430, and the shift illumination pattern 440 (hereinafter referred to as cases 5 to 8). With this configuration, it is possible to obtain an effect of improving the resolution by two times in the vertical direction and the horizontal direction by the processing in the signal processing unit 150.

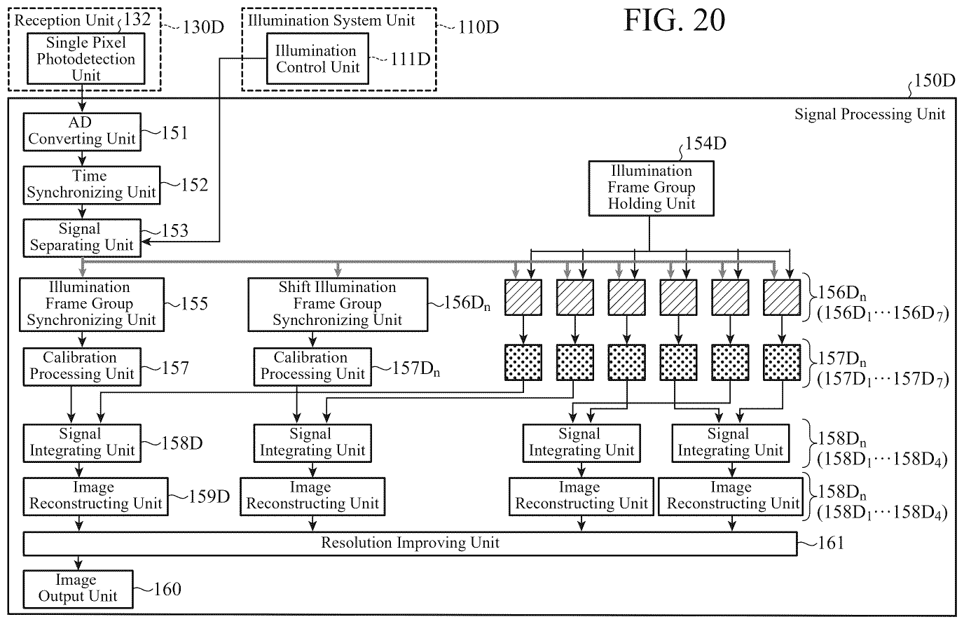

FIG. 20 is a diagram illustrating a configuration example of the signal processing unit 150D in the image acquiring device 100D according to the fifth embodiment of the present disclosure.

Hereinafter, the same components as those in the first, second, third, and fourth embodiments will be denoted by the same names and the same or similar reference numerals, and the configuration will be described focusing on differences from the first, second, third, and fourth embodiments.

The signal separating unit 153 has a function of determining and separating the signals corresponding to cases 1 to 8 from the reception signal from the time synchronizing unit 152 using the timing information from an illumination control unit 111D. Furthermore, a function of transmitting a signal corresponding to each case to the illumination frame group synchronizing unit 155 or the shift illumination frame group synchronizing unit 156D (156Dn: n=1, 2, 3, 4, 5, 6, and 7) is also included.

The signal integrating unit 158D (158Dn: n=1, 2, 3, and 4) connects a plurality of input illumination frame groups and a plurality of reception signals, respectively, to create an integrated reception signal and an integrated illumination frame group. The fifth embodiment includes four signal integrating units 158, and integrates case 1 and case 3, case 2 and case 4, case 5 and case 7, and case 6 and case 8. In the cases to be integrated, corresponding illumination patterns are shifted by one section in the vertical direction. Based on case 1, case 2 is shifted by a 1/2 section in the vertical direction, case 5 is shifted by a 1/2 section in the horizontal direction, and case 7 is shifted by a 1/2 section in the vertical and horizontal directions.

The image reconstructing unit 159D (159Dn: n=1, 2, 3, and 4) is connected to the subsequent stage of each signal integrating unit 158D (158Dn: n=1, 2, 3, and 4), and applies the image reconstruction processing to the integrated reception signal and the integrated illumination frame group output from the signal integrating unit 158 (158Dn: n=1, 2, 3, and 4) to generate the two-dimensional image of the measurement target 200 (four in total). Each two-dimensional image output by the image reconstructing unit 159 (159Dn: n=1, 2, 3, and 4) is shifted by 1/2 pixels as described above.

The signal processing unit 150D further includes a resolution improving unit 161 that performs, on the reception signal, resolution improvement processing of improving resolution of an image based on the reception signal.

The resolution improving unit 161 has a function of receiving four two-dimensional images output from the image reconstructing unit 159 (159Dn: n=1, 2, 3, and 4), and outputting a resolution-improved image having twice the resolution of these images in the horizontal direction and the vertical direction. Since the four input images are shifted by 1/2 pixels in the horizontal and vertical directions, the resolution is improved by integrating these images using a so-called sub-pixel shift method.

### [Operation]

A processing example of the image acquiring device according to the fifth embodiment of the present disclosure will be described.

Hereinafter, the configuration will be described focusing on differences from the first, second, third, and fourth embodiments.

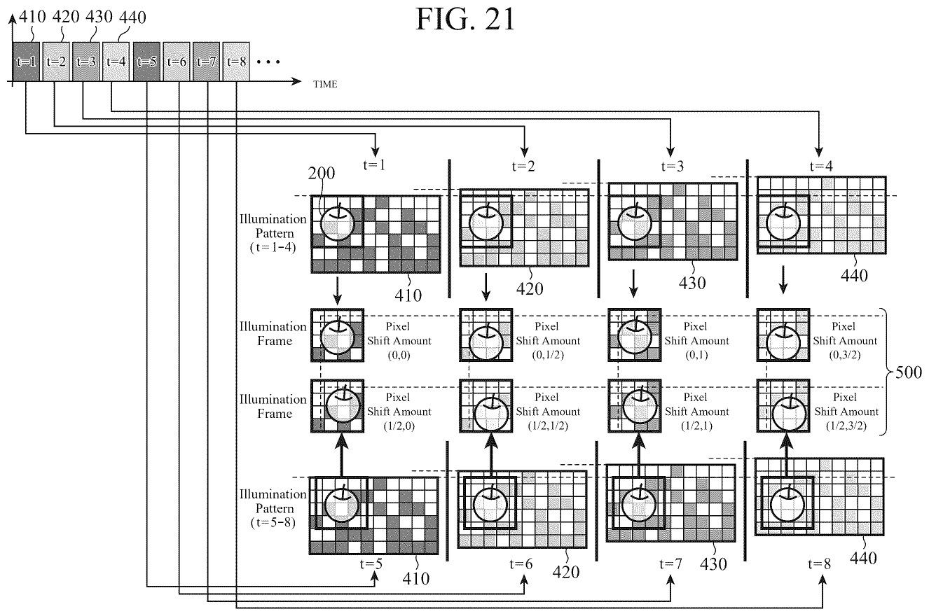

FIG. 21 is a diagram for describing an operation related to acquisition of a reception signal in the image acquiring device 100D according to the fifth embodiment of the present disclosure.

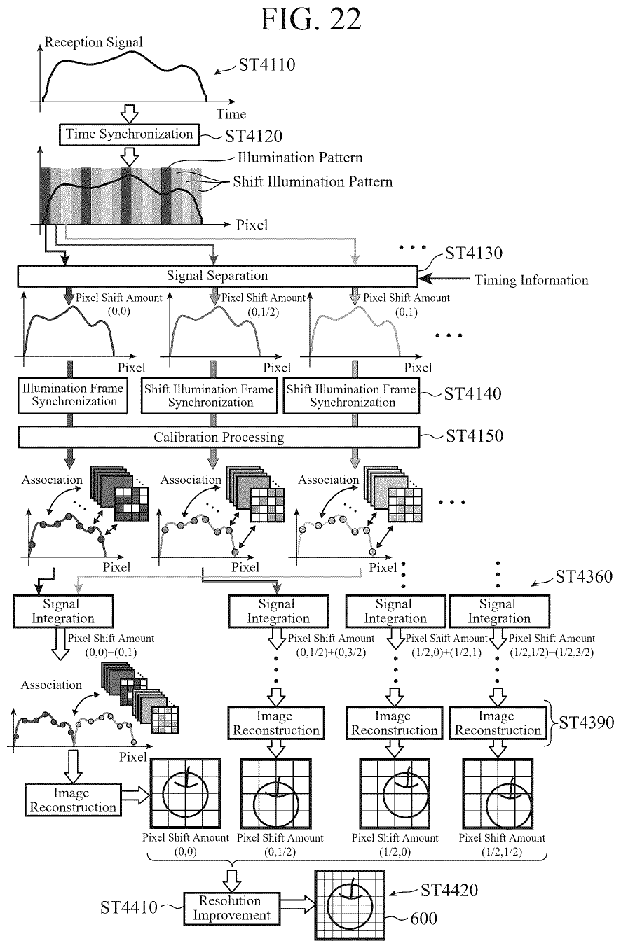

FIG. 22 is a diagram for describing processing related to the signal processing unit 150D in the image acquiring device 100D according to the fifth embodiment of the present disclosure.

Differences from the fourth embodiment are that the number of patterns output from the illumination system unit 110D is increased, the shift amount of the illumination pattern in the vertical direction is 1/2 sectioned, and the reception signal is acquired eight times while the measurement target 200 moves by one section. Since each of the details of the processing contents of steps ST4110 to ST4420 illustrated in FIG. 22 is similar to the processing contents already described, different processing contents will be described below.

Assuming that the section shift amount in the horizontal direction based on the illumination pattern 410 is ΔX and the section shift amount in the vertical direction is ΔY, signals are acquired in the following eight cases.
Case 1: section shift (ΔX, ΔY)=(0, 0) (=illumination pattern 410)
Case 2: section shift (ΔX, ΔY)=(0, 1/2) (=shift illumination pattern 420)
Case 3: section shift (ΔX, ΔY)=(0, 1) (=shift illumination pattern 430)
Case 4: section shift (ΔX, ΔY)=(0, 3/2) (=shift illumination pattern 440)
Case 5: section shift (ΔX, ΔY)=(1/2, 0) (=section shift (ΔX, ΔY) to illumination pattern 410=(1/2, 0))
Case 6: section shift (ΔX, ΔY)=(1/2, 1/2) (=section shift (ΔX, ΔY) to shift illumination pattern 420=(1/2, 0))
Case 7: section shift (ΔX, ΔY)=(1/2, 1) (=section shift (ΔX, ΔY) to shift illumination pattern 430=(1/2, 0))
Case 8: section shift (ΔX, ΔY)=(1/2, 3/2) (=section shift (ΔX, ΔY) to shift illumination pattern 440=(1/2, 0))

Since signals are acquired in the above-described 8 cases each time the measurement target 200 moves by one section, signal separation processing similar to that in the first embodiment is performed to separate the signals into reception signals corresponding to the respective cases (step STST4130).

Cases 1 and 3 are obtained by shifting the illumination pattern 410 by one section in the vertical direction, and can be used to increase the substantial number of illumination frames by the signal integration processing (step ST4360) as in the second embodiment. The same applies to case 2 and case 4, case 5 and case 7, and case 6 and case 8. On the other hand, case 2 and case 4 are shifted from case 1 and case 3 by (ΔX, ΔY)=(0, 1/2). Case 5 and case 7, and case 6 and case 8 are also shifted by (ΔX, ΔY)=(1/2, 0) and (1/2, 1/2). Therefore, when image reconstruction is performed using these cases, an output image shifted by the above amount with respect to the output images in case 1 and case 3 is obtained. Therefore, a total of four images captured by the half section shift are obtained (step ST4390).

Since the four output images are so-called subpixel-shifted images, it is possible to newly create an image in which the resolution is doubled in each of the horizontal direction and the vertical direction by integrating the images by the resolution improvement processing (resolution improvement processing: step ST4410). The image quality may be improved by performing deconvolution processing or the like, as necessary.

Since a 1/2 pixel shift is sufficient for normal sub-pixel shift processing, there is no rational reason to set a shift amount exceeding one pixel such as case 3, case 4, case 7, and case 8. On the other hand, in the present embodiment, since the processing for increasing the number of illumination frames is performed in addition to the resolution improvement by the sub-pixel shift, a signal is acquired even with a shift amount exceeding one pixel.

Hereinafter, conditions for satisfying the above operation will be organized.

As a precondition, in a state in which the image acquiring device 100D is disposed in such a manner as to measure the moving measurement target 200, a shift direction of the illumination pattern is a vertical direction α with respect to a moving direction 250 of the measurement target, a moving speed of the measurement target 200 is defined as v, a partition interval in the vertical direction of the illumination pattern 410 is defined as d_{y}, a partition interval in the horizontal direction of the illumination pattern 410 is defined as dₓ, a length on the measurement target corresponding to the pixel interval in the vertical direction of the two-dimensional image output from the signal processing unit 150 is defined as d′_{y}, and a length on the measurement target corresponding to a pixel interval in the horizontal direction of the two-dimensional image output from the signal processing unit 150 is defined as d′ₓ.

At this time, the degree of resolution improvement ρ_{y} in the vertical direction is ρ_{y}=d_{y}/d′_{y}, and a coefficient ρₓ representing the degree of resolution improvement in the horizontal direction is ρₓ=dₓ/d′ₓ. If the resolution is not improved, d_{y}=d′_{y} and dₓ=d′ₓ, and thus ρ_{y}=ρₓ=1.

The number of illumination patterns to be shifted is set to N. The total number of patterns including the illumination pattern 410 is N+1. The total number of illumination patterns is restricted by the condition for improving the resolution in the vertical direction and the condition for obtaining the effect of increasing the number of illumination frames. First, in order to improve the resolution by ρ_{y}, N+1>=ρ_{y} needs to be satisfied. For example, in order to double the resolution in the vertical direction, at least two types of shift amounts of (ΔX, ΔY)=(0, 0) and (0, 1/2) are required. Furthermore, in order to obtain an increase in illumination frame, it is necessary to shift each shift amount by one section in the vertical direction. Since the minimum number of illumination frames increased is two, N+1>=2*ρ_{y}. Therefore, the condition for the number of illumination patterns to be shifted for the establishment of the present embodiment is N>=2*ρ_{y}−1.

The shift interval in the vertical direction of the illumination pattern is set to Δd_{y}, and the maximum shift distance is set to d_{y,max}. The shift interval in the vertical direction relates to the resolution improvement in the vertical direction. For example, if the resolution is to be improved by a factor of 2 (ρ_{y}=2), then Δd_{y}<=d_{y}/2 needs to be, and generalizing this leads to a constraint Δd_{y}<=d_{y}/ρ_{y}. On the other hand, as d_{y,max}, since a value obtained by multiplying the pattern interval d_{y} by the number of patterns N is required at the minimum, d_{y,max}>=Δd_{y}*N is a constraint using the number of patterns N.

In the fifth configuration of the present embodiment, ρ_{y}=ρₓ=2, N=3, Δd_{y}=1/2*d_{y}, d_{y,max}=3/2*d_{y}, and the above constraint is satisfied. On the other hand, when the purpose is only to increase the resolution, N=1, d_{y,max}=1/2*d_{y} is sufficient, and there is no rational reason to configure and operate in such a manner as to satisfy the above constraint conditions.

Note that, in the configuration of the fifth embodiment, ρ_{y}=ρₓ=2. However, when the above condition is satisfied even when ρ_{y}=ρₓ>2, the resolution improvement effect and the illumination frame increase effect can be obtained. When ρ_{y}=ρₓ=1, N=1 and Δd_{y}=d_{y,max}=1 match the conditions of the first embodiment, and the above constraint conditions are further satisfied.

Note that the minimum number of samples required to improve the resolution and increase the number of illumination frames is ρₓ*(N+1) times while the measurement target 200 moves by one section. When illumination pattern switching and signal acquisition are performed at equal intervals, it is necessary to satisfy the following constraint: the switching cycle Δtₚ of the illumination pattern is Δtₚ<=(dₓ/v)/(ρₓ*(N+1)), and the signal acquisition cycle Δtₛ is Δtₛ<=(dₓ/v)/(ρₓ*(N+1)).

Further, a constraint condition on the number of illumination pattern sections is also specified. The number of sections in the vertical direction of the illumination pattern 410 is set as M_{y}, the number of sections in the horizontal direction is set as Mₓ, the number of pixels in the vertical direction of the two-dimensional image output from the signal processing unit is set as M′_{y}, and the number of pixels in the horizontal direction is set as M′ₓ. The illumination pattern 410 needs to have such a number of sections that the measurement target 200 fits in the illumination pattern 410 even when the illumination pattern 410 is shifted by d_{y,max}. The number of sections corresponding to d_{y,max} is d_{y,max}/d_{y}, and the number of sections corresponding to the measurement target 200 is M′_{y}/ρ_{y} obtained by reclaiming the resolution improvement of M′_{y}. Therefore, My needs to satisfy the relationship of M_{y}>=M′_{y}/ρ_{y}+d_{y,max}/d_{y}. In addition, Mₓ needs to satisfy the relationship of Mₓ>>M′ₓ/ρₓ from the viewpoint of ensuring a sufficient number of illumination frames.

In normal SPI, there is no rational reason for not matching M_{y} and M′_{y}/ρ_{y} from the viewpoint of maximizing the resolution of the output image. In the present disclosure, since the illumination pattern is shifted, it is necessary to satisfy the above-described constraint conditions.

### Effects According to Fifth Embodiment

With the configuration as in the present embodiment, it is possible to obtain the resolution improvement effect of the output image while maintaining the effect of substantially increasing the number of illumination frames.

The image acquiring device of the present disclosure according to the present embodiment is further configured as follows, for example.

An image acquiring device including:
an illumination system unit to irradiate a measurement target with an illumination pattern applied with a two-dimensional pattern formed using a plurality of sections and a shift illumination pattern obtained by shifting the illumination pattern along an irradiation surface;
a reception unit to receive, via a single pixel photodetector, light from the measurement target when the illumination pattern and the shift illumination pattern are irradiated onto the measurement target by the illumination system unit; and
a signal processing unit to acquire a reception signal based on the light received by the reception unit and generate a two-dimensional image of the measurement target on the basis of a change in the reception signal when the measurement target passes on the illumination pattern and a change in the reception signal when the measurement target passes on the shift illumination pattern,
the illumination system unit including:
a light source unit;
a pattern generating unit to apply a two-dimensional pattern to light emitted from the light source unit;
an illumination optical system to project the light to which the two-dimensional pattern is applied by the pattern generating unit onto a measurement target; and
an illumination pattern shift unit to shift an illumination pattern generated by the illumination optical system,
the pattern generating unit being configured by a static structure that applies the two-dimensional pattern that is single to the light emitted from the light source unit, and
the illumination system unit emitting the illumination pattern and one or more shift illumination patterns obtained by shifting the illumination pattern by the illumination pattern shift unit while switching the illumination pattern and the one or more shift illumination patterns depending on a lapse of time, in which
in a state in which the image acquiring device is disposed in such a manner as to measure the moving measurement target, a shift direction of the illumination pattern is a vertical direction with respect to a moving direction of the measurement target, and
the illumination pattern and the shift illumination pattern irradiated by the illumination system unit are configured in such a manner that
when it is defined that a movement speed of the measurement target is v,
a section interval in the vertical direction with respect to the moving direction of the measurement target in the illumination pattern is d_{y},
a section interval in a horizontal direction with respect to the moving direction of the measurement target in the illumination pattern is dₓ,
a length on the measurement target corresponding to a pixel interval in the vertical direction of a two-dimensional image output from the signal processing unit is d′_{y},
a length on the measurement target corresponding to a pixel interval in the horizontal direction of the two-dimensional image output from the signal processing unit is d′ₓ,
a coefficient ρ_{y} is ρ_{y}=d_{y}/d′_{y}, and
a coefficient ρₓ is ρₓ=dₓ/d′ₓ,
a number N of the shift illumination patterns satisfies a condition of N>=2*ρ_{y}−1,
a shift interval Δd_{y} of the shift illumination pattern in the vertical direction satisfies a relationship of Δd_{y}<=d_{y}/ρ_{y},
a maximum shift distance d_{y,max} in the vertical direction of the shift illumination pattern satisfies a relationship of d_{y,max}>=Δd_{y}*N, and
a number Nₛ of times of signal acquisition while the measurement target passes through one section of the illumination pattern satisfies a relationship of Nₛ>=ρₓ*(N+1) times.

The image acquiring device of the present disclosure according to the present embodiment is further configured as follows, for example.

The image acquiring device, in which
when the illumination pattern irradiated by the illumination system unit is defined as
a number of sections in the vertical direction of the illumination pattern being M_{y},
a number of sections in the horizontal direction of the illumination pattern being Mₓ,
a number of pixels in the vertical direction of the two-dimensional image output from the signal processing unit being M′_{y}, and
a number of pixels in the horizontal direction of the two-dimensional image output from the signal processing unit being M′ₓ,
the number of sections My in the vertical direction of the illumination pattern satisfies a relationship of M_{y}>=M′_{y}/ρ_{y}+d_{y,max}/d_{y}, and
the number of sections Mₓ in the horizontal direction of the illumination pattern satisfies a relationship of Mₓ>>M′ₓ/ρₓ.

The image acquiring device of the present disclosure according to the present embodiment is further configured as follows, for example.

The image acquiring device, in which
one of the coefficient ρ_{y} and the coefficient ρₓ is 2 or more, and
the signal processing unit performs, on a reception signal, resolution improvement processing for improving resolution of an image based on the reception signal.

The image acquiring device of the present disclosure according to the present embodiment is further configured as follows, for example.

The image acquiring device, in which a relative position between the measurement target and the illumination pattern in the horizontal direction and a relative position between the measurement target and the shift illumination pattern in the horizontal direction
do not change upon switching between the illumination pattern and the shift illumination pattern.

The image acquiring device of the present disclosure according to the present embodiment is further configured as follows, for example.

An image acquiring device including:
an illumination system unit to irradiate a measurement target with an illumination pattern applied with a two-dimensional pattern formed using a plurality of sections and a shift illumination pattern obtained by shifting the illumination pattern along an irradiation surface;
a reception unit to receive, via a single pixel photodetector, light from the measurement target when the illumination pattern and the shift illumination pattern are irradiated onto the measurement target by the illumination system unit; and
a signal processing unit to acquire a reception signal based on the light received by the reception unit and generate a two-dimensional image of the measurement target on the basis of a change in the reception signal when the measurement target passes on the illumination pattern and a change in the reception signal when the measurement target passes on the shift illumination pattern,
the illumination system unit including:
a light source unit;
a pattern generating unit to apply a two-dimensional pattern to light emitted from the light source unit;
an illumination optical system to project the light to which the two-dimensional pattern is applied by the pattern generating unit onto a measurement target; and
an illumination pattern shift unit to shift an illumination pattern generated by the illumination optical system,
the reception unit including a plurality of single pixel photodetectors, which is included in the single pixel photodetector, to receive light from the measurement target when the illumination pattern and the shift illumination pattern are irradiated onto the measurement target by the illumination system unit,
the pattern generating unit being configured by a static structure that applies the two-dimensional pattern that is single to the light emitted from the light source unit,
the illumination system unit simultaneously irradiating the illumination pattern and one or more shift illumination patterns obtained by shifting the illumination pattern by the illumination pattern shift unit, and
the plurality of single pixel photodetectors separately detecting the illumination pattern and the shift illumination patterns, in which
in a state in which the image acquiring device is disposed in such a manner as to measure the moving measurement target, a shift direction of the illumination pattern is a vertical direction with respect to a moving direction of the measurement target, and
the illumination pattern and the shift illumination pattern irradiated by the illumination system unit are configured in such a manner that
when it is defined that a movement speed of the measurement target is v,
a section interval in the vertical direction with respect to the moving direction of the measurement target in the illumination pattern is d_{y},
a section interval in a horizontal direction with respect to the moving direction of the measurement target in the illumination pattern is dₓ,
a length on the measurement target corresponding to a pixel interval in the vertical direction of a two-dimensional image output from the signal processing unit is d′_{y},
a length on the measurement target corresponding to a pixel interval in the horizontal direction of the two-dimensional image output from the signal processing unit is d′ₓ,
a coefficient ρ_{y} is ρ_{y}=d_{y}/d′_{y}, and
a coefficient ρₓ is ρₓ=dₓ/d′ₓ,
a number N of the shift illumination patterns satisfies a condition of N>=2*ρ_{y}−1,
a shift interval Δd_{y} of the shift illumination pattern in the vertical direction satisfies a relationship of Δd_{y}<=d_{y}/ρ_{y}, and
a maximum shift distance d_{y,max} in the vertical direction of the shift illumination pattern satisfies a relationship of d_{y,max}>=Δd_{y}*N.

The image acquiring device of the present disclosure according to the present embodiment is further configured as follows, for example.

The image acquiring device, in which
when the illumination pattern irradiated by the illumination system unit is defined as
a number of sections in the vertical direction of the illumination pattern being My,
a number of sections in the horizontal direction of the illumination pattern being Mₓ,
a number of pixels in the vertical direction of the two-dimensional image output from the signal processing unit being M′_{y}, and
a number of pixels in the horizontal direction of the two-dimensional image output from the signal processing unit being M′ₓ,
the number of sections My in the vertical direction of the illumination pattern satisfies a relationship of M_{y}>=M′_{y}/ρ_{y}+d_{y,max}/d_{y}, and
the number of sections Mₓ in the vertical direction of the illumination pattern satisfies a relationship of Mₓ>>M′ₓ/ρₓ.

The image acquiring device of the present disclosure according to the present embodiment is further configured as follows, for example.

The image acquiring device, in which
one of the coefficient ρ_{y} and the coefficient ρₓ is 2 or more, and
the signal processing unit performs, on a reception signal, resolution improvement processing for improving resolution of an image based on the reception signal.

Here, a hardware configuration for implementing the functions of the present disclosure will be described.

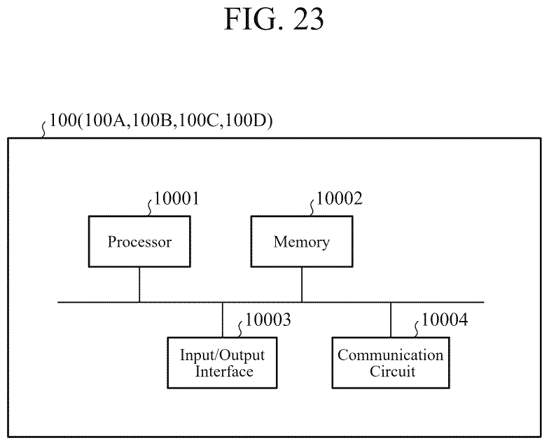

FIG. 23 is a diagram illustrating a first example of a hardware configuration for implementing the function according to the present disclosure.

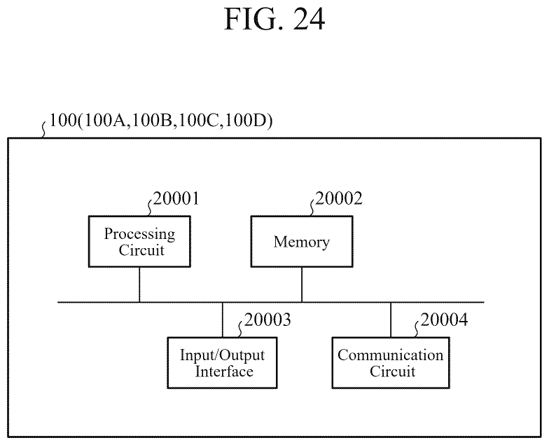

FIG. 24 is a diagram illustrating a second example of a hardware configuration for implementing the function according to the present disclosure.

In particular, the illumination control units 111, 111A, 111B, 111C, 111C-1, 111C-2, and 111D and the signal processing units 150, 150A, 150B, 150C, and 150D in the image acquiring devices 100, 100A, 100B, 100C, and 100D of the present disclosure are implemented by hardware as illustrated in FIG. 23 or 24.

In particular, the illumination control units 111, 111A, 111B, 111C, 111C-1, 111C-2, and 111D and the signal processing units 150, 150A, 150B, 150C, and 150D in the image acquiring devices 100, 100A, 100B, 100C, and 100D are each configured by, for example, a processor 10001, a memory 10002, an input/output interface 10003, and a communication circuit 10004 as illustrated in FIG. 23.

The processor 10001 and the memory 10002 are mounted on a computer, for example.

The memory 10002 stores a program for causing the computer to function as the illumination control units 111, 111A, 111B, 111C, 111C-1, 111C-2, and 111D, the signal processing units 150, 150A, 150B, 150C, and 150D, and a control unit, which is not illustrated. The processor 10001 reads and executes the program stored in the memory 10002, thereby implementing the functions of the illumination control units 111, 111A, 111B, 111C, 111C-1, 111C-2, and 111D, the signal processing units 150, 150A, 150B, 150C, and 150D, and a control unit, which is not illustrated.

Further, a storage unit that is not illustrated is implemented by the memory 10002 or another memory that is not illustrated.

Further, a communication unit, which is not illustrated, is implemented by the communication circuit 10004.

The processor 10001 uses, for example, a central processing unit (CPU), a graphics processing unit (GPU), a microprocessor, a microcontroller, a digital signal processor (DSP), or the like.

The memory 10002 may be a nonvolatile or volatile semiconductor memory such as a random access memory (RAM), a read only memory (ROM), an erasable programmable read only memory (EPROM), an electrically erasable programmable read only memory (EEPROM), a flash memory, or the like, a magnetic disk such as a hard disk or a flexible disk, or an optical disk such as a compact disc (CD) or a digital versatile disc (DVD).

The processor 10001 and the memory 10002 or the communication circuit 10004 are connected in a state capable of transmitting data to each other. Further, the processor 10001 and the memory 10002 or the communication circuit 10004 are connected in a state in which data can be mutually transmitted with other hardware via an input/output interface 10003.

Alternatively, the functions of the illumination control units 111, 111A, 111B, 111C, 111C-1, 111C-2, and 111D, the signal processing units 150, 150A, 150B, 150C, and 150D, and the control unit, which is not illustrated, in the image acquiring devices 100, 100A, 100B, 100C, and 100D may be implemented by a dedicated processing circuit 20001 as illustrated in FIG. 24.

The processing circuit 20001 uses, for example, a single circuit, a composite circuit, a programmed processor, a parallel programmed processor, an application specific integrated circuit (ASIC), a programmable logic device (PLD), a field-programmable gate array (FPGA), a system-on-a-chip (SoC), a system large-scale integration (LSI), or the like.

Further, a storage unit that is not illustrated is implemented by the memory 20002 or another memory that is not illustrated.

The memory 20002 may be a nonvolatile or volatile semiconductor memory such as a random access memory (RAM), a read only memory (ROM), an erasable programmable read only memory (EPROM), an electrically erasable programmable read only memory (EEPROM), a flash memory, or the like, a magnetic disk such as a hard disk or a flexible disk, or an optical disk such as a compact disc (CD) or a digital versatile disc (DVD).

Furthermore, a communication unit which is not illustrated is implemented by the communication circuit 20004.

The processing circuit 20001 and the memory 20002 or the communication circuit 20004 are connected in a state in which data can be transmitted to each other. Further, the processing circuit 20001, the memory 20002, and the communication circuit 20004 are connected in a state in which data can be mutually transmitted with other hardware via an input/output interface 20003.

Note that the functions of the illumination control units 111, 111A, 111B, 111C, 111C-1, 111C-2, and 111D, the signal processing units 150, 150A, 150B, 150C, and 150D, and the control unit, which is not illustrated, in the image acquiring devices 100, 100A, 100B, 100C, and 100D may be implemented by different processing circuits, or may be collectively implemented by the processing circuits.

Similarly, the functions of the image acquiring unit 301A, the operation determination unit 302A, and a control unit not illustrated in the occupant monitoring device 300A may be implemented by different processing circuits, or may be collectively implemented by a processing circuit.

Similarly, the functions of the operating information collecting unit 601E and the control unit not illustrated in the server device 600E may be implemented by different processing circuits, or may be collectively implemented by a processing circuit.

Alternatively, some of the functions of the illumination control units 111, 111A, 111B, 111C, 111C-1, 111C-2, and 111D, the signal processing units 150, 150A, 150B, 150C, and 150D, and the control unit, which is not illustrated, in the image acquiring devices 100, 100A, 100B, 100C, and 100D may be implemented by the processor 10001 and the memory 10002, and the remaining functions may be implemented by the processing circuit 20001.

Note that, within the scope of the present disclosure, the embodiments can be freely combined, any component of the embodiments can be modified, or any component of the embodiments can be omitted.

### INDUSTRIAL APPLICABILITY

This disclosure is suitable for use in measurement devices, for example, that acquire and measure two-dimensional images of a measurement target using a single illumination pattern. It enables increasing the number of apparent illumination patterns (illumination frames) while suppressing the increase in the size of the illumination pattern.

### REFERENCE SIGNS LIST

100, 100A, 100B, 100C, 100D: image acquiring device, 110, 110A, 110B, 110C, 110C-1, 110C-2, 110D: illumination system unit, 111, 111A, 111B, 111C, 111C-1, 111C-2, 111D: illumination control unit, 112A, 112C: time-multiplexed light source unit (light source unit), 112A-1, 112B-1: monochromatic laser (light source unit), 112A-2, 112B-2: monochromatic laser (light source unit), 112A-3, 112B-3: beam combiner, 112B: multiplex light source unit, 112C-1: multi-wavelength laser, 113: fixed pattern generating unit (pattern generating unit), 113-1: illumination pattern mask (pattern generating unit), 114: pattern multiplexing unit (illumination pattern shift unit), 114-1: prism (illumination pattern shift unit), 115: illumination optical system, 115-1: illumination lens, 116: illumination pattern mask moving unit (pattern moving unit), 130, 130A, 130B, 130C, 130D: reception Unit, 131: reception optical system, 132, 132A: single pixel photodetection unit (single pixel photodetection device), 132B-1, 132B-2: single pixel photodetection unit (a plurality of single pixel photodetection devices), 133: pattern separating unit, 150, 150A, 150B, 150C, 150D: signal processing unit, 151: AD converting unit, 152: time synchronizing unit, 153: signal separating unit, 154: illumination frame group holding unit, 155: illumination frame group synchronizing unit, 156, 156C-1, 156C-2, 156D (156Dₙ: n=1, 2, 3, 4, 5, 6, 7): shift illumination frame group synchronizing unit, 157, 157a, 157b, 157c, 157D (157Dₙ: n=1, 2, 3, 4, 5, 6, 7): calibration processing unit, 158, 158D (158Dₙ: n=1, 2, 3, 4): signal integrating unit, 159, 159D (159Dₙ: n=1, 2, 3, 4): image reconstructing unit, 160: image output unit, 161: resolution improving unit, 200: measurement target, 250: moving direction of measurement target, 300: object driving unit (object driving device), 400: pattern light, 410: illumination pattern (first illumination pattern), 420: shift illumination pattern (first shift illumination pattern) (second illumination pattern), 430: shift illumination pattern (second shift illumination pattern) (third illumination pattern), 440: shift illumination pattern (third shift illumination pattern) (fourth illumination pattern), 500, 500₁, 500₂, 500₃, 500₄, 500₅, 500₆, 500₇, 500A, 500B: illumination frame, 600: image, 10001: processor, 10002: memory, 10003: input/output interface, 10004: communication circuit, 20001: processing circuit, 20002: memory, 20003: input/output interface, 20004: communication circuit

1. An image acquiring device comprising:
an illumination system to irradiate a measurement target with an illumination pattern applied with a two-dimensional pattern formed using a plurality of sections and a shift illumination pattern obtained by shifting the illumination pattern along an irradiation surface;
a receptor to receive, via a single pixel photodetector, light from the measurement target when the illumination pattern and the shift illumination pattern are irradiated onto the measurement target by the illumination system; and
a signal processor to acquire a reception signal based on the light received by the receptor and generate a two-dimensional image of the measurement target on a basis of a change in the reception signal when the measurement target passes on the illumination pattern and a change in the reception signal when the measurement target passes on the shift illumination pattern.

2. The image acquiring device according to claim 1, wherein
the illumination system includes:
a light source;
a pattern generator to apply a two-dimensional pattern to light emitted from the light source;
an illumination optical system to project the light to which the two-dimensional pattern is applied by the pattern generator onto a measurement target; and
an illumination pattern shifter to shift an illumination pattern generated by the illumination optical system,
the pattern generator is configured by a static structure that applies a single of the two-dimensional pattern to the light emitted from the light source, and
the illumination system emits the illumination pattern and one or more shift illumination patterns obtained by shifting the illumination pattern by the illumination pattern shifter while switching the illumination pattern and the one or more shift illumination patterns depending on a lapse of time.

3. The image acquiring device according to claim 2, wherein
in a state in which the image acquiring device is disposed in such a manner as to measure the moving measurement target, a shift direction of the illumination pattern is a vertical direction with respect to a moving direction of the measurement target, and
the illumination pattern and the shift illumination pattern irradiated by the illumination system are configured in such a manner that
when it is defined that a movement speed of the measurement target is v,
a section interval in the vertical direction with respect to the moving direction of the measurement target in the illumination pattern is d_{y},
a section interval in a horizontal direction with respect to the moving direction of the measurement target in the illumination pattern is dₓ,
a length on the measurement target corresponding to a pixel interval in the vertical direction of a two-dimensional image output from the signal processor is d′_{y},
a length on the measurement target corresponding to a pixel interval in the horizontal direction of the two-dimensional image output from the signal processor is d′ₓ,
a coefficient ρ_{y} is ρ_{y}=d_{y}/d′_{y}, and
a coefficient ρₓ is ρₓ=dₓ/d′ₓ,
a number N of the shift illumination patterns satisfies a condition of N>=2*ρ_{y}−1,
a shift interval Δd_{y} of the shift illumination pattern in the vertical direction satisfies a relationship of Δd_{y}<=d_{y}/ρ_{y},
a maximum shift distance d_{y,max} in the vertical direction of the shift illumination pattern satisfies a relationship of d_{y,max}>=Δd_{y}*N, and
a number Nₛ of times of signal acquisition while the measurement target passes through one section of the illumination pattern satisfies a relationship of Nₛ>=ρₓ*(N+1) times.

4. The image acquiring device according to claim 3, wherein
when the illumination pattern irradiated by the illumination system is defined as
a number of sections in the vertical direction of the illumination pattern being M_{y},
a number of sections in the horizontal direction of the illumination pattern being Mₓ,
a number of pixels in the vertical direction of the two-dimensional image output from the signal processor being M′_{y}, and
a number of pixels in the horizontal direction of the two-dimensional image output from the signal processor being M′ₓ,
the number of sections My in the vertical direction of the illumination pattern satisfies a relationship of M_{y}>=M′_{y}/ρ_{y}+d_{y,max}/d_{y}, and
the number of sections Mx in the horizontal direction of the illumination pattern satisfies a relationship of Mₓ>>M′ₓ/ρₓ.

5. The image acquiring device according to claim 4, wherein
one of the coefficient ρ_{y} and the coefficient ρₓ is 2 or more, and
the signal processor performs, on the reception signal, resolution improvement processing for improving resolution of an image based on the reception signal.

6. The image acquiring device according to claim 4, wherein
a relative position between the measurement target and the illumination pattern in the horizontal direction and a relative position between the measurement target and the shift illumination pattern in the horizontal direction
do not change upon switching between the illumination pattern and the shift illumination pattern.

7. The image acquiring device according to claim 6, comprising
a pattern mover to change a shift direction of the shift illumination pattern.

8. The image acquiring device according to claim 1, wherein
the illumination system includes:
a light source;
a pattern generator to apply a two-dimensional pattern to light emitted from the light source;
an illumination optical system to project the light to which the two-dimensional pattern is applied by the pattern generator onto a measurement target; and
an illumination pattern shifter to shift an illumination pattern generated by the illumination optical system,
the receptor includes a plurality of single pixel photodetectors, to receive light from the measurement target when the illumination pattern and the shift illumination pattern are irradiated onto the measurement target by the illumination system,
the pattern generator is configured by a static structure that applies a single of the two-dimensional pattern to the light emitted from the light source,
the illumination system simultaneously irradiates the illumination pattern and one or more shift illumination patterns obtained by shifting the illumination pattern by the illumination pattern shifter, and
the plurality of single pixel photodetectors separately detect the illumination pattern and the shift illumination patterns.

9. The image acquiring device according to claim 8, wherein
in a state in which the image acquiring device is disposed in such a manner as to measure the moving measurement target, a shift direction of the illumination pattern is a vertical direction with respect to a moving direction of the measurement target, and
the illumination pattern and the shift illumination pattern irradiated by the illumination system are configured in such a manner that
when it is defined that a movement speed of the measurement target is v,
a section interval in the vertical direction with respect to the moving direction of the measurement target in the illumination pattern is d_{y},
a section interval in a horizontal direction with respect to the moving direction of the measurement target in the illumination pattern is dₓ,
a length on the measurement target corresponding to a pixel interval in the vertical direction of a two-dimensional image output from the signal processor is d′_{y},
a length on the measurement target corresponding to a pixel interval in the horizontal direction of the two-dimensional image output from the signal processor is d′ₓ,
a coefficient ρ_{y} is ρ_{y}=d_{y}/d′_{y}, and
a coefficient ρₓ is ρₓ=dₓ/d′ₓ,
a number N of the shift illumination patterns satisfies a condition of N>=2*ρ_{y}−1,
a shift interval Δd_{y} of the shift illumination pattern in the vertical direction satisfies a relationship of Δd_{y}<=d_{y}/ρ_{y}, and
a maximum shift distance d_{y,max} in the vertical direction of the shift illumination pattern satisfies a relationship of d_{y,max}>=Δd_{y}*N.

10. The image acquiring device according to claim 9, wherein
when the illumination pattern irradiated by the illumination system is defined as
a number of sections in the vertical direction of the illumination pattern being My,
a number of sections in the horizontal direction of the illumination pattern being Mx,
a number of pixels in the vertical direction of the two-dimensional image output from the signal processor being M′_{y}, and
a number of pixels in the horizontal direction of the two-dimensional image output from the signal processor being M′ₓ,
the number of sections M_{y} in the vertical direction of the illumination pattern satisfies a relationship of M_{y}>=M′_{y}/ρ_{y}+d_{y,max}/d_{y}, and
the number of sections Mₓ in the vertical direction of the illumination pattern satisfies a relationship of Mₓ>>M′ₓ/ρₓ.

11. The image acquiring device according to claim 10, wherein
one of the coefficient ρ_{y} and the coefficient ρₓ is 2 or more, and
the signal processor performs, on the reception signal, resolution improvement processing for improving resolution of an image based on the reception signal.

12. An image acquiring method performed by an image acquiring device, the image acquiring method comprising:
irradiating a measurement target with an illumination pattern applied with a two-dimensional pattern formed using a plurality of sections and a shift illumination pattern obtained by shifting the illumination pattern along a pattern surface;
receiving light from the measurement target irradiated with the illumination pattern and the shift illumination pattern via a single pixel photodetector; and
acquiring a reception signal based on the light received via the single pixel photodetector, and generating a two-dimensional image of the measurement target on a basis of a change in the reception signal when the measurement target passes on the illumination pattern and a change in the reception signal when the measurement target passes on the shift illumination pattern.
